(19) United States
(12) Patent Application Publication
(10) Pub. No.: US 2025/0238664 A1
(43) Pub. Date: Jul. 24, 2025

(54) ADAPTATION OF QUANTIZATION OF NEURAL NETWORK MODELS DURING INFERENCE

(71) Applicant: Intel Corporation, Santa Clara, CA (US)

(72) Inventors: Javier Sebastian Turek, Beaverton, OR (US); Javier Felip Leon, Hillsboro, OR (US); David Gonzalez Aguirre, Portland, OR (US); Julio Cesar Zamora Esquivel, West Sacramento, CA (US)

(73) Assignee: Intel Corporation, Santa Clara, CA (US)

(21) Appl. No.: 18/599,863

(22) Filed: Mar. 8, 2024

(51) Int. Cl. G06N 3/0495

(52) U.S. Cl. CPC G06N 3/0495

(57) ABSTRACT

Quantization is a technique that may be used to reduce precision while maintaining performance of a neural network model during training of the neural network model, or before the neural network model is deployed. During inference, a neural network model with a fixed quantization level is used to produce predictions. In online services, such as running neural network models continuously or frequently for long periods of time in data centers, the neural network model with a fixed quantization level may not always perform optimally due to changes and/or shifts in system load and input data during inference time. A flexible and adaptive approach to quantization and a system to support adaptive quantization during inference time can be employed to address such concerns.

### BACKGROUND

Deep learning models (e.g., convolutional neural networks, transformer-based models, etc.) are used in a variety of artificial intelligence and machine learning applications such as computer vision, speech recognition, and natural language processing. Deep learning models may receive and process input such as images, videos, audio, speech, text, etc. Deep learning models can generate outputs, such as features and predictions, based on the input.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawings.

Figure (FIG. 1 illustrates an exemplary neuron having quantization, according to some embodiments of the disclosure.

FIG. 2 illustrates an exemplary transformer-based node having quantization, according to some embodiments of the disclosure.

FIG. 3 illustrates exemplary operations for model preparation, according to some embodiments of the disclosure.

FIG. 4 illustrates exemplary operations for model analysis, according to some embodiments of the disclosure.

FIG. 5 illustrates exemplary operations for short-term adaptation, according to some embodiments of the disclosure.

FIG. 6 illustrates an exemplary method performed by a short-term decision engine, according to some embodiments of the disclosure.

FIG. 7 illustrates exemplary operations for long-term adaptation, according to some embodiments of the disclosure.

FIG. 8 illustrates exemplary method performed by a long-term decision engine, according to some embodiments of the disclosure.

FIG. 9 illustrates exemplary operations for a long-term decision engine, according to some embodiments of the disclosure.

FIG. 10 is a flowchart showing a method for adaptive quantization of a model during/at inference time, according to some embodiments of the disclosure.

FIG. 11 is a block diagram of an exemplary computing device, according to some embodiments of the disclosure.

FIG. 12 is a block diagram of an exemplary computing system, according to some embodiments of the disclosure.

### DETAILED DESCRIPTION

### Overview

Many artificial intelligence applications and online services implement pipelines that include one or more underlying machine learning models. The machine learning models may produce predictions based on input data. Examples of input data may include one or more of: image, video, audio, sensor data, tabular data, maps, graphs, time-series data, three-dimensional or multi-dimensional data, natural language text, embeddings, output of another neural network, and output of another model. Examples of machine learning models may include deep learning models, neural network models, transformer-based neural network models, generative neural network models, etc. Some pipelines may include large neural network models, e.g., deep learning neural network models, and transformer-based neural network models, which may be trained with billions or even trillions of parameters capturing information from humongous data quantities. Consequently, their large model size can pose a high cost during inference time, e.g., runtime, compute costs, and memory costs. Prior to deployment, the models may be optimized with one or more techniques such as pruning and quantization to reduce their sizes and improve runtime during inference.

Quantization is a technique that may be used to reduce precision while maintaining performance of a neural network model during training of the neural network model, or before the neural network model is deployed. During inference, a neural network model with a fixed quantization level is used to produce predictions. Quantization may be a technique of choice because quantization conducts near-equivalent computations with a lower number of bits, increasing the speed and reducing the memory used to store parameters while reducing energy and runtime of computing the activations. However, quantization may come with some limitations. Low bitrates (e.g., below 4 or 8 bits) may be hard to achieve without loss of model performance. Desired model performance may be achievable using floating-point representations that would have to be specially implemented in hardware and imply that the same representation type is applied for all network parameters or activations. Some quantization schemes are performed using training data at hand before the model is used for inference, limiting potential gains from considering factors such as system load and input data shifts.

In online services, such as running neural network models continuously or frequently for long periods of time in data centers, the neural network model with a fixed quantization level may not always perform optimally due to changes and/or shifts in system load and input data during inference time. Opportunities to increase or decrease quantization levels would be missed.

A flexible and adaptive approach to quantization and a system to support adaptive quantization during inference time can be employed to address such concerns or shortcomings. In some embodiments, a system can be implemented to update the bitrate of a neural network model (e.g., adjust the quantization level of parameters and/or activations) during inference time. The system can (continuously or routinely) monitor the performance of the neural network model during inference time and may adapt the neural network model's quantization level based on the information about the environment and its usage.

Before deploying the neural network model, the system may perform model preparation to precompute parameters for different quantization options/levels. The precomputed parameters may be loaded into memory to be used during inference. Different quantization options/levels may be determined based on system information. Different quantization options/levels may be determined based on analytics of the neural network model generated using training data.

The system can achieve adaptation at runtime (e.g., during inference) by selecting precomputed quantized parameters corresponding to the desired quantization option/level to be used during inference. The system can achieve the adaptation at runtime (e.g., during inference) by selecting the desired quantization option/level to be used during inference. The desired quantization option/level can be determined based static system information. Static system information may include one or more attributes about the neural network model. Static system information may include one or more attributes about the one or more computing systems being used to execute the neural network model. Static system information may include one or more attributes about one or more executions of the neural network model by the one or more computing systems.

After deploying the model and during inference time, the updates and/or adjustments may be determined by considering input data to the neural network model and data produced by the neural network model during inference time. By accumulating analytics and analyzing them on-the-fly, during inference time, the system can decide better quantization values for each operation in the neural network model, considering information such as recent input distribution, hardware system load, hardware system utilization level, user configuration, etc.

In some cases, the updates and/or adjustments may be determined based on current information about the computing system on which the neural network model is implemented. Such adaptation may enable the system to react to current system load or utilization level and user constraints at runtime, and the system can modify quantization levels accordingly. In some cases, the updates and/or adjustments may be determined based on short-term information, or current system information about the computing system on which the neural network model is implemented. Short-term information or current system information can include one or more attributes about the one or more computing systems being used to execute the neural network model. Short-term information or current system information may include one or more attributes about one or more executions of the neural network model by the one or more computing systems.

In some cases, the updates and/or adjustments may be determined based on accumulated, long-term information about the neural network model and/or the computing system on which the neural network model is implemented. Such adaptation may enable the system to detect input distribution shifts and modify quantization levels accordingly. In some cases, the updates and/or adjustments may be determined based on predicted performance generated based on the accumulated, long-term information about the neural network model and/or the computing system on which the neural network model is implemented.

The system may receive as input the operations to be performed by a neural network model, and the data that is to be computed or produced by the neural network model. The system may consider system information (e.g., static system information, current system information, historical system information) and desired quality of the neural network model.

The system may tradeoff quality to balance the hardware system load or utilization level. The system may perform tradeoffs based on short-term information (e.g., current information, or instantaneous information). The system may perform tradeoffs based on long-term information (e.g., information gathered over a longer time scale or over a period of time, or trends). The system may perform tradeoffs based on user provided configurations and/or preferences, such as maximum error tolerable/acceptable by the user, and minimum bitrate allowable by the user). The tradeoffs may include making changes to the quantization level or selecting a quantization option/level which complements or reacts to the attributes or information about one or more executions of the neural network model by the one or more computing systems. The tradeoffs may include making changes to the quantization level or selecting a quantization option/level which achieves one or more objectives for one or more executions of the neural network model by the one or more computing systems.

In some embodiments, the Hadamard transform may be used as part of quantization (e.g., in the precomputing of parameters for different quantization options/levels) to achieve high quality while performing hardware-based integer operations with ultra-low bitrates (e.g., 1, 2, or 3 bits). The system can take advantage of the characteristics of the Hadamard Transform for a highly efficient and adaptable quantization to integer (INT) representation that can be switched in runtime (e.g., during inference). Implementing quantization can inevitably lose information and cause some quantization error. The use of the Hadamard transform can help to reduce the quantization error. The Hadamard transform can correct the original distribution of values to be closer to a uniform distribution. When the number of dimensions increases, the quantization error can be lower for small bitrate quantization schemes via the use of the Hadamard transform. Larger neural network models with billions of parameters can be less influenced or impacted by quantization errors. In some cases, an increase in the quantization error can be acceptable to the user (e.g., owner of the neural network model). The tolerable error can be taken into account when making updates/adaptations to the quantization level of the neural network model. Also, in some cases, an increase in the quantization error may be unnoticeable for some applications and use cases.

In one example, quantization aware training quantizes a neural network model during the training process. Quantization aware training utilizes training data available at the time of training to produce a neural network model with a desired quantization level (e.g., INT8). The systems described herein improves upon and/or differs from quantization aware training by enabling adaptiveness of quantization during inference.

In another example, post-training (but pre-inference) quantization may receive a trained neural network as input and a desired quantization level and use additional data to analyze and quantize the model to maintain its performance as much as possible. The systems described herein improves upon and/or differs from post-training quantization by allowing more flexibility in choosing the quantization level across a model, by allowing runtime tradeoffs that can maximize performance, and by allowing changes to the quantization level in response to shifts in the input data distribution at inference.

In yet another example, a hardware processor may adaptively compute precision/quantization levels (e.g., fp8 or 8-bit floating-point, fp16 or 16-bit floating-point, and bf16 or 16-bit brain floating-point) when executing specific operations in a transformer-based neural network model during training. The trained model remains in its original precision during inference. The systems described herein improves upon and/or differs from the hardware processor by enabling adaptive quantization during inference that considers changes in the neural network model's environment and its performance, and by allowing ultra-low bit levels (e.g., 1-bit, 2-bit, or 3-bit) integer operations (as opposed to using floating points, which may use more silicon area on tensor units).

In some embodiments, the systems described herein may enable switching bitrates at low cost. The systems described herein may enable hardware-friendly low or ultra-low bitrate quantization. The systems described herein can be applied to a variety of neural network models of different types such as transformer-based neural network models, and artificial-neuron-based neural network models.

In some embodiments, the systems described herein involves execution of large number of inferences with adaptation of quantization levels, and the systems described herein can allow users (e.g., owners) of artificial intelligence services to vertically scale and adapt the pipelines to changes in performance of neural network models and in the environment of the neural network models on demand. Such features may be particularly beneficial in online systems or on-premises systems, where runtime performance is a constant, pressing concern. Examples of online applications may include running large language models and or vision-based models for manufacturing processes. Scaling advantages can translate into lower costs, and higher availability, and can enable elastic-infrastructure capabilities on demand. Adaptability of quantization levels may also result in computational savings and energy savings (or maximizing efficiencies and utility of resources) for cloud providers and users.

Herein, quantization option may be synonymous with quantization level.

### Quantization in Neural Network Models

Quantization in a neural network model may involve reducing precision of numbers or values in the neural network model, such as parameters (e.g., weights, and biases), and activations (e.g., inputs and outputs to neurons/nodes). The numbers or values are stored in memory, and quantization may reduce the amount of memory required to store the numbers or values and/or improve runtime performance of operations that operate on the numbers or values. The neural network model may include thousands, millions, billions, or trillions of operations that operate on such numbers and values. Quantization may reduce the precision of numbers or values by converting the numbers or values from a larger representation (e.g., floating-point representation) to a smaller representation (e.g., INTs or integer representation). Quantization can make the numbers or values more compact (e.g., uses fewer bits).

The extent of the reduction of precision may be referred to herein as quantization level. It may be possible to have one or more (different) quantization levels for a given operation in a neural network model that corresponds to one or more (different) quantization levels. Quantization level may be the same for all operations in the neural network model. Quantization level may vary across the operations in the neural network model. Quantization may be applied to a subset of operations in the neural network model. In some cases, one or more operations which follow a given operation in a neural network model may have the same quantization level applied as the quantization level applied for the given operation.

The following passages describe applying quantization with an optional Hadamard transform for different types of operations that may be in a neural network model, such as a neuron, and transformer node.

The Hadamard transform can achieve very low quantization errors for uniform quantization. The Hadamard transform is a fast orthonormal (unitary) transform (e.g., H^{T}H=HH^{T}=I with I being the identity matrix/operator). The Hadamard transform only uses additions (no multiplications). Therefore, the Hadamard transform can be cheap to implement (even in hardware). The Hadamard transform transforms the distribution to be closer to a uniform distribution. For example, the Hadamard transform can achieve very good results for quantizing gradients down to 1 bit to reduce communications during training of large neural network models.

FIG. 1 illustrates an exemplary neuron 102 having quantization, according to some embodiments of the disclosure. Neuron 102 may be an artificial neuron, which can be used as a building block of a neural network model. Many neurons implemented in a same or similar manner as neuron 102 may be interconnected in a network to form a neural network model.

Neuron 102 may receive one or more inputs, shown as activation(s) 104. Neuron 102 may apply weight(s) 110 to the activation(s) 104. Neuron 102 may sum the one or more weighted inputs. Neuron 102 may apply an activation function to the sum of the one or more weighted inputs. The activation function may include a non-linear activation (e.g., sigmoid function, rectified linear unit function, etc.). Neuron 102 may produce one or more outputs after applying the activation function, shown as output(s) 112.

Quantizer 106 may be provided to quantize activation(s) 104. Quantizer 106 may reduce the precision of activation(s) 104 according to a specified quantization level or option. Quantizer 106 may optionally apply a Hadamard transform to activation(s) 104.

Quantizer 108 may be provided to quantize weight(s) 110. Quantizer 108 may reduce the precision of weight(s) 110 according to a specified quantization level or option. Quantizer 108 may optionally apply a Hadamard transform to weight(s) 110.

Suppose weight(s) 110 of a layer are stored in matrix W. The activation(s) 104 (e.g., output(s) from a neuron in a previous layer) can be given by matrix A. Multiplying of the two matrices, A and W, and applying the Hadamard transform and quantization can be represented as follows:

$$A \cdot W = A \cdot {HH}^{T} \cdot W = ( AH ) \cdot ( {H}^{T} W ) ≅ {[ AH ]}_{q} \cdot {[ {H}^{T} W ]}_{q} \qquad ( eq . 1 )$$

H is the Hadamard transform, and [⋅]_{q} is the representation of the number using only q bits.

Application of the Hadamard transform by quantizer 106 to activation(s) 104 can be represented by (AH). Quantization by quantizer 106 to activation(s) 104 can be represented by [AH]_{q}.

Application of the Hadamard transform by quantizer 108 to weight(s) 110 can be represented by (H^{T}W). Quantization by quantizer 106 to activation(s) 104 can be represented by [H^{T}W]_{q}.

Quantizer 106 may quantize output(s) 112.

The operation performed by neuron 102 illustrated in FIG. 1 involving multiplication of the two matrices, A and W, can be common in neural networks. Various techniques for applying quantization to the operation described herein can be applied to a variety of neural network models, such as multi-layer perceptron networks, convolutional neural networks, recurrent neural networks, etc.

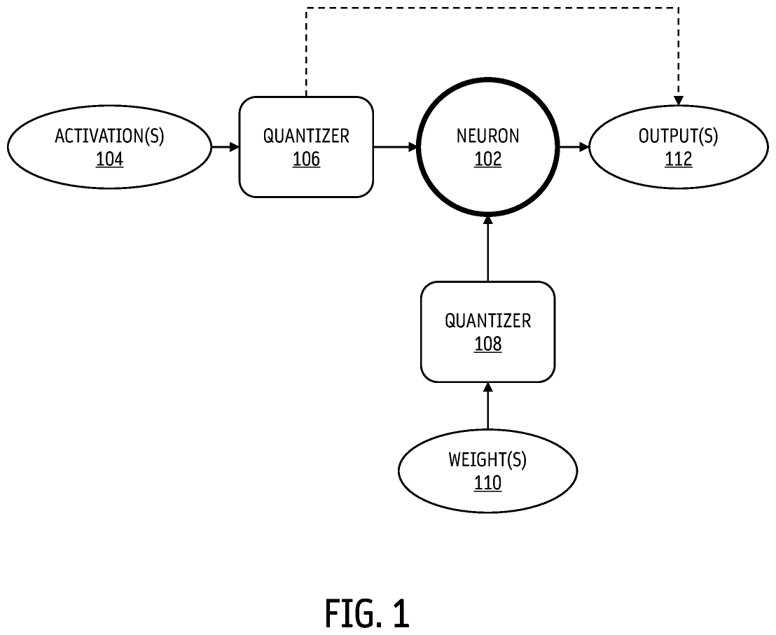

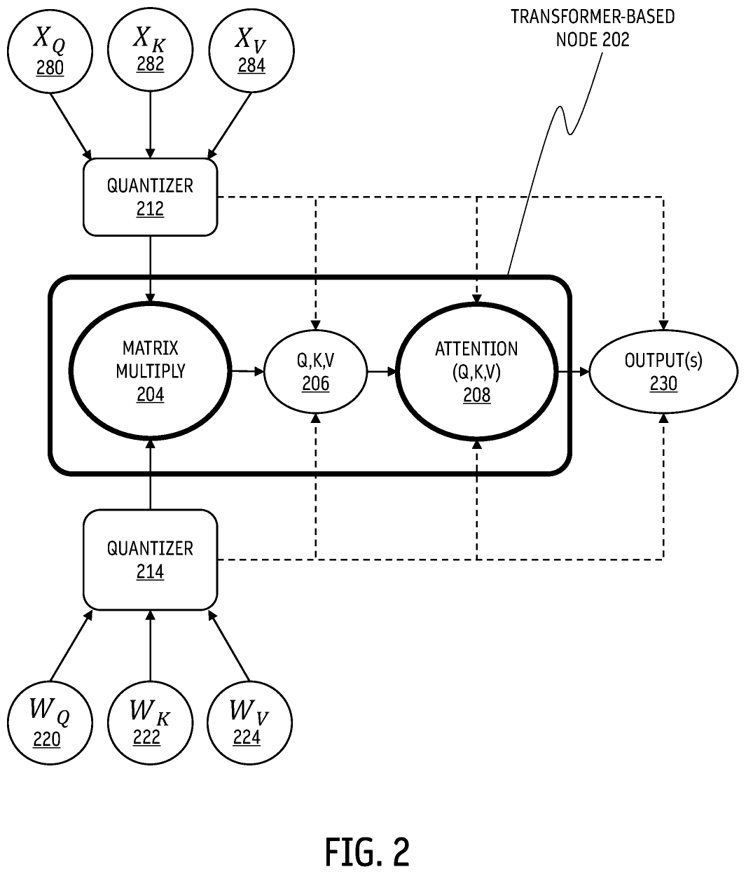

FIG. 2 illustrates an exemplary transformer-based node 202 (or neuron) having quantization, according to some embodiments of the disclosure. Transformer-based node 202 may be a building block of a transformer-based neural network model. Transformer-based node 202 may be referred to as an attention head in an encoder and/or a decoder of a transformer-based node 202. Transformer-based node 202 may attend to different parts of the input, which may ultimately help contribute to an understanding of the input. Many nodes or attention heads implemented in a same or similar manner as transformer-based node 202 may be interconnected in a network to form a transformer-based neural network model.

Transformer-based node 202 may receive one or more inputs, shown as X_{Q} 280, X_{K} 282, and X_{V} 284. One or more inputs, e.g., one or more of X_{Q} 280, X_{K} 282, and X_{V} 284, may include an input embedding. In a self-attention case of transformer-based node 202, X_{Q} 280, X_{K} 282, and X_{V} 284 are the same. In a cross-attention case of transformer-based node 202, X_{Q} 280, X_{K} 282, and X_{V} 284 may be different (e.g., in some cases of cross-attention scenarios, X_{Q} 280 is different from X_{K} 282, and X_{V} 284 and X_{K} 282, and X_{V} 284 may be the same).

Transformer-based node 202 may include matrix multiply 204. Matrix multiply 204 may perform matrix multiplication of X_{Q} 280 with W_{Q} 220 to produce Q in Q,K,V 206 (e.g., X_{Q}W_{Q}=Q). Q in Q,K,V 206 may be referred to as query. W_{Q} 220 may be referred to as query weights. Matrix multiply 204 may perform matrix multiplication of X_{K} 282 with W_{K} 222 to produce K in Q,K,V 206 (e.g., X_{K}W_{K}=K). K in Q,K,V 206 may be referred to as key. W_{K} 222 may be referred to as key weights. Matrix multiply 204 may perform matrix multiplication of X_{V} 284 with W_{V} 226 to produce V in in Q,K,V 206 (e.g., X_{V}W_{V}=V). V in Q,K,V 206 may be referred to as values. W_{V} 226 may be referred to as value weights.

Q,K,V 206 are provided as input to attention (Q,K,V) 208 to produce one or more outputs, shown as output(s) 230. Attention (Q,K,V) 208 may apply a softmax function, e.g.:

$$softmax ( \frac{Q {K}^{T}}{\sqrt{d}} ) V = softmax ( \frac{{X}_{Q} {W}_{Q} {W}_{K}^{T} {X}_{K}^{T}}{\sqrt{d}} ) {W}_{V} {X}_{V} \qquad ( eq . 2 )$$

Q, K, and V may be the query, key, and value inputs (respectively) to the attention (Q,K,V) 208. W_{Q} 220, W_{K} 220 and W_{V} are the weights of the linear transformations applied to X_{Q} 280, X_{K} 282, and X_{V} 284 respectively by matrix multiply 204. \sqrt{d} may be a normalization factor with d being the dimension of the transformed vectors from keys and queries. The softmax function may convert input values to the softmax function into output values that sum up to 1.

Quantizer 212 may be provided to quantize one or more of X_{Q} 280, X_{K} 282, and X_{V} 284. Quantizer 212 may reduce the precision of values in one or more of X_{Q} 280, X_{K} 282, and X_{V} 284 according to a specified quantization level or option. Quantizer 212 may optionally apply the Hadamard transform to one or more of X_{Q} 280, X_{K} 282, and X_{V} 284.

Quantizer 214 may be provided to quantize W_{Q} 220. Quantizer 214 may reduce the precision of W_{Q} 220 according to a specified quantization level or option. Quantizer 214 may optionally apply the Hadamard transform to W_{Q} 220. Quantizer 214 may be provided to quantize W_{K} 222. Quantizer 214 may optionally apply the Hadamard transform to W_{K} 222. Quantizer 214 may reduce the precision of W_{K} 222 according to a specified quantization level or option. Quantizer 214 may be provided to quantize W_{V} 224. Quantizer 214 may reduce the precision of W_{V} 222 according to a specified quantization level or option. Quantizer 214 may optionally apply the Hadamard transform to W_{V} 224.

In some cases, the operations performed by attention (Q,K,V) 208 with the Hadamard transform and/or quantization applied can be represented as follows:

$$Attn ( Q , K , V ) = softmax ( \frac{{X}_{Q} {W}_{Q} {W}_{K}^{T} {X}_{{K}^{T}}}{\sqrt{d}} ) {W}_{V} {X}_{V} = softmax ( \frac{{X}_{Q} {W}_{Q} H {H}^{T} {W}_{K}^{T} {X}_{K}^{T}}{\sqrt{d}} ) {W}_{V} {X}_{V} = softmax ( \frac{( {X}_{Q} {W}_{Q} H ) ( {H}^{T} {W}_{K}^{T} {X}_{K}^{T} )}{\sqrt{d}} ) {W}_{V} {X}_{V} ≅ softmax ( \frac{{{[ {X}_{Q} {W}_{Q} H ]}_{q} [ {H}^{T} {W}_{K}^{T} {X}_{K}^{T} ]}_{q}}{\sqrt{d}} ) {W}_{V} {X}_{V} \qquad ( eq . 3 )$$

H is the Hadamard transform, and [⋅]_{q} is the representation of the number using only q bits.

Application of the Hadamard transform by quantizer 212 and/or quantizer 214 can be represented by application of HH^{T} to the term QK^{T}=X_{Q}W_{Q}W_{K}^{T}X_{K}^{T} in

$$softmax ( \frac{{X}_{Q} {W}_{Q} H {H}^{T} {W}_{K}^{T} {X}_{K}^{T}}{\sqrt{d}} ) {W}_{V} {X}_{V} .$$

The Hadamard transform may be applied by quantizer 212 and/or quantizer 214 in attention (Q,K,V) 208 after multiplying Q and K^{T}.

Application of the Hadamard transform by quantizer 214 to W_{Q} 220 can be represented by W_{Q}H. Application of the Hadamard transform by quantizer 214 to W_{K} 222 can be represented by H^{T}W_{K}^{T}.

Quantization by quantizer 212 and/or quantizer 214 can be represented by [X_{Q}W_{Q}H]_{q}, [H^{T}W_{K}^{T}X_{K}^{T}]_{q}, etc.

Quantizer 212 and/or quantizer 214 may quantize other terms/quantities in transformer-based node 202, such as X_{Q} W_{Q}, W_{K}^{T}X_{K}^{T}, W_{V} and W_{V}V.

Quantizer 212 and/or quantizer 214 may quantize output(s) 230, e.g., the output of attention (Q,K,V) 208, e.g.,

$$softmax ( \frac{{X}_{Q} {W}_{Q} {W}_{K}^{T} {X}_{K}^{T}}{\sqrt{d}} ) {W}_{V} {X}_{V} = softmax ( \frac{{X}_{Q} {W}_{Q} H {H}^{T} {W}_{K}^{T} {X}_{K}^{T}}{\sqrt{d}} ) {W}_{V} {X}_{V} .$$

### Model Preparation

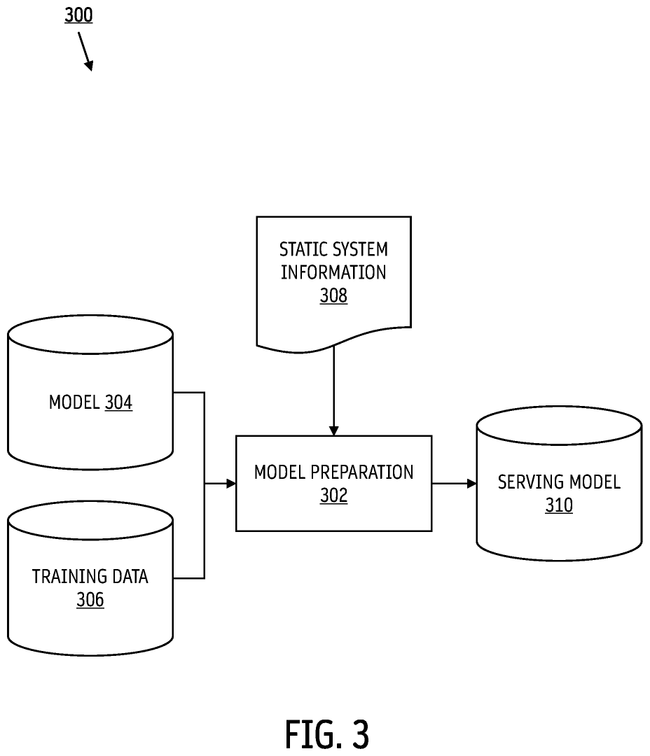

FIG. 3 illustrates exemplary operations for model preparation, according to some embodiments of the disclosure. FIG. 3 depicts components 300 (e.g., one or more components implementing one or more operations, and one or more components storing data used in the one or more operations).

Before deploying a model, model preparation 302 performs one or more operations for model preparation. Model 304 (e.g., a neural network model) may be ready to be deployed. In some cases, model preparation 302 may train model 304 (e.g., without any quantization applied) using training data 306. Model preparation 302 may fine-tune model 304 using training data 306. Model preparation 302 may obtain trained parameters of model 304.

Model preparation 302 may modify model 304 to generate serving model 310, which would be used during inference time. Model preparation 302 may add one or more Hadamard transform operations in model 304 so that the one or more transform operations are included in serving model 310. Model preparation 302 may add one or more quantization operations in model 304 so that the one or more quantization operations are included in serving model 310. Model preparation 302 may perform operations to prepare serving model 310 to be able to switch (seamlessly) between different quantization options during/at inference time. In some embodiments, model preparation 302 may produce serving model 310 to be able to switch between different quantization options (e.g., different quantization levels, different bitrates, different bit sizes, etc.) in individual operations in serving model 310. Model preparation 302 may produce serving model 310, e.g., a modified version of model 304, with changes that would allow serving model 310 to change the bitrate or quantization level at individual operations of serving model 310 at/during inference.

Model preparation 302 may receive static system information 308. Static system information 308 may include information about the destination system, such as one or more computing systems on which the serving model 310 will be deployed or used to execute the serving model 310 during/at inference time. Static system information 308 may include one or more attributes about an execution of the neural network model by one or more computing systems.

Model preparation 302 may determine one or more (available) quantization options for model 304 (e.g., a neural network model). Model preparation 302 may determine the one or more quantization options (e.g., representing different bit sizes) based on static system information 308. Model preparation 302 may determine the one or more quantization options based on user input. Model preparation 302 may determine an initial set of quantization options for individual operations in serving model 310. Static system information 308 may guide model preparation 302 (e.g., as constraints) to determine the initial set of quantization options. In some embodiments, model preparation 302 may determine determining a quantization option (among one or more quantization options) for a neural network model based on one or more first attributes about an execution of the neural network model by one or more computing systems.

Static system information 308 may include one or more user preferences relating to desired quantization levels and/or desired quality levels. Static system information 308 may include one or more user preferences relating to desired performance of model 304. User preferences may include a minimum bitrate requirement. User preferences may include a maximum bitrate requirement. User preferences may include a maximum quality requirement. User preferences may include a minimum quality requirement. User preferences may include a bitrate range requirement. User preferences may include a (minimum or maximum) number of quantization options to consider. User preferences may include user configurations or settings. User preferences may include a maximum number of requests the serving model 310 is expected to serve. User preferences may include a minimum number of requests the serving model 310 is expected to serve. The user preferences may include preferences of one or more users associated with the one or more computing systems.

Static system information 308 may include information about hardware capabilities of the one or more computing systems to be used to execute serving model 310. Static system information 308 may include an amount of assigned compute resources. An amount of assigned compute resources may include a number of processors to be used in the one or more computing systems to execute serving model 310. Static system information 308 may include one or more types of assigned compute resources. One or more types of assigned compute resources may include a type of processor to be used in the one or more computing systems to execute serving model 310 (e.g., central processing unit (CPU), graphics processing unit (GPU), data processing unit (DPU), field programmable gate array (FPGA), a tensor processing unit (TPU), etc.).

Static system information 308 may include an amount of assigned memory resources. An amount of assigned memory resources may include memory capacity of the one or more computing systems to be used to execute serving model 310. An amount of assigned memory resources may include data storage capacity of the one or more computing systems to be used to execute serving model 310. Static system information 308 may include one or more types of assigned memory resources. One or more types of assigned memory resources may include a type of memory to be used in the one or more computing systems to execute serving model 310 (e.g., random access memory (RAM), solid state hard drive (SSD) storage, on-chip cache, networked storage, etc.).

Assigned resources, as used herein, may include resources which have been assigned, allotted, allocated, or specified for one or more executions of the neural network model.

Static system information 308 may include information about model 304. Static system information 308 may include a number of operations in the model 304 (e.g., the neural network model). Static system information 308 may include information about one or more bottlenecks in the model 304 or information about one or more operations that may benefit from quantization. Static system information 308 may include execution time about one or more operations in model 304. Static system information 308 may include size of model 304 (e.g., number of operations, number of parameters, number of activations, etc.).

Model preparation 302 may prepare serving model 310 by preparing serving model 310 with precomputed quantized parameters that correspond the different quantization options. In some cases, model preparation 302 may prepare serving model 310 by preparing serving model 310 with precomputed (transformed) parameters that suitable for quantization during inference time. Model preparation 302 may compute one or more parameters for the one or more quantization options, wherein at least one of the one or more parameters are to be used by the neural network during/at inference time. The one or more parameters may be computed based on trained/learned parameters of model 304. In some embodiments, model preparation 302 may compute a parameter value for an internal parameter of the neural network model using a value of the internal parameter determined from training the neural network model. The computed parameter value may correspond to the quantization option/level.

An internal parameter of the neural network model may include a weight of the neural network model. A weight may be in the form of a weight matrix. In some cases, an internal parameter of the neural network may include a bias of the neural network model. The value of the weight or bias can be determined or learned by training the neural network model with training data and updating the value of the weight or bias based on the training. Computing a parameter value that corresponds to the quantization option may involve applying a Hadamard transform to the weight or bias to obtain the computed parameter value. A computed parameter value may include a weight that has the Hadamard transform applied thereto. Computing a parameter value that corresponds to the quantization level may involve performing a quantization operation to the parameter value or a derivation thereof to obtain the computed parameter value. A computed parameter value may include a weight that has the Hadamard transform and a quantization operation applied thereto.

In some embodiments, model preparation 302 may apply a uniform quantization technique to improve the performance (e.g., accuracy) of a quantized model or reduce the error caused by quantization. Uniform quantization technique works by ensuring that the data to be quantized (e.g., parameters and activations of the neural network model) is closer to a uniform distribution. One mechanism to modify the distribution of the data to be quantized is by applying a Hadamard transform. Model preparation 302 modifies model 304 to produce serving model 310 that would utilize the Hadamard transform when quantizing activations at/during inference time.

Model preparation 302 modifies model 304 to include quantization operations in serving model 310 (e.g., in the computational graph of serving model 310) to quantize activations or quantities which are to be quantized or computed during/at inference time. The quantization operation may include application of the Hadamard transform. The quantization operation may include application of a quantization operation to reduce the bit size representation according to the corresponding quantization option. The quantization option may include a variable quantization operation to reduce the bit size representation according to a selected/configured quantization option.

Referring back to the illustrated example in FIG. 1 and equation 1, the quantized activations [AH]_{q} can be computed during/at inference time by serving model 310 with the matching value of q bits corresponding to the quantization option of the operation. Model preparation 302 may include one or more operations in serving model 310 to quantize activations, e.g., to compute the Hadamard transform, i.e., AH, and its posterior quantization [AH]_{q} on the activations A.

Referring back to the illustrated example in FIG. 2 and equation 3, the quantized results of the matrix multiplications can be computed during/at inference time by serving model 310 with the matching value of q bits corresponding to the quantization option of the operation. Model preparation 302 may include one or more operations in serving model 310 to quantize the quantity X_{Q} W_{Q}H to obtain [X_{Q}W_{Q}H]_{q}. Model preparation 302 may include one or more operations in serving model 310 to quantize the quantity H^{T}W_{K}^{T}X_{K}^{T} to obtain [H^{T}W_{K}^{T}X_{K}^{T}]_{q}. Model preparation 302 may include one or more operations in serving model 310 to quantize the quantity X_{Q}W_{Q} to obtain [X_{Q}W_{Q}]_{q}. Model preparation 302 may include one or more operations in serving model 310 to quantize the quantity W_{K}^{T}X_{K}^{T} to obtain [W_{K}^{T}X_{K}^{T}]_{q}. Model preparation 302 may include one or more operations in serving model 310 to quantize the quantity W_{V}X_{V} to obtain [W_{V}X_{V}]_{q}. Model preparation 302 may include one or more operations in serving model 310 to quantize the quantity

$$softmax ( \frac{{X}_{Q} {W}_{Q} H {H}^{T} {W}_{K}^{T} {X}_{K}^{T}}{\sqrt{d}} ) to obtain {[ softmax ( \frac{{X}_{Q} {W}_{Q} H {H}^{T} {W}_{K}^{T} {X}_{K}^{T}}{\sqrt{d}} ) ]}_{q} .$$

In some cases, model preparation 302 may compute one or more quantized parameters for different quantization options so that serving model 310 may switch quantization options on-the-fly during inference. In some cases, model preparation 302 may compute one or more transformed parameters suitable to be used with different quantization options so that serving model 310 may more efficiently switch quantization options on-the-fly during inference.

Serving model 310 may be saved/stored with precomputed quantized parameters and/or precomputed transformed parameters corresponding to different quantization options (e.g., different bitrates). Serving model 310 may be loaded onto the one or more computing systems that are to be used for executing serving model 310. The one or more precomputed quantized parameters, with serving model 310, for the one or more quantization options, can be loaded into one or more memories of the one or more computing systems that are to be used for executing serving model 310. In some cases, a selected subset of the one or more precomputed quantized parameters, with serving model 310, for a selected subset of the one or more quantization options are loaded into one or more memories of the one or more computing systems that are to be used for executing serving model 310. In some cases, at least a subset of the one or more precomputed quantized parameters, with serving model 310, for at least a subset of the one or more quantization options are loaded into one or more memories of the one or more computing systems that are to be used for executing serving model 310. The one or more precomputed transformed parameters, with serving model 310, can be loaded into one or more memories of the one or more computing systems that are to be used for executing serving model 310. Loading may include sending the parameters to the one or more memories. Loading may include causing the parameters to be stored in the one or more memories. Loading may include writing the parameters to the one or more memories. Loading may include causing the parameters to be made accessible or usable by the serving model 310.

In some embodiments, one or more quantized parameters may be computed for each quantization option for each operation in model 304. The computed quantized parameters may be included with serving model 310.

In some embodiments, one or more transformed parameters may be computed for various quantization options for each operation in model 304. The computed transformed parameters may be included with serving model 310.

Model preparation 302 may apply a Hadamard transform to one or more parameters to obtain one or more transformed parameters. Model preparation 302 may quantize the transformed parameters according to the one or more quantization options.

Referring back to the illustrated example in FIG. 1 and equation 1, quantized parameters [H^{T}W]_{q}, can be computed for different quantization options (or values of q) by model preparation 302 and may be saved/stored with serving model 310. Model preparation 302 may apply a transposed Hadamard matrix H^{T} to the weights W to obtain transformed weights H^{T}W. 302 may apply different quantization options to produce different versions of the quantized parameters [H^{T}W]_{q}, for the different quantization options.

Referring back to the illustrated example in FIG. 2 and equation 3, transformed parameters W_{Q}H and/or H^{T}W_{K}^{T} can be computed by model preparation 302. The quantities from the matrix multiplications, X_{Q}W_{Q}H and H^{T}W_{K}^{T}X_{K}^{T}, may then be quantized according to a selected quantization option q during/at inference time to obtain [X_{Q} W_{Q}H]_{q} and [H^{T}W_{K}^{T}X_{K}^{T}]_{q} respectively. This implementation can quantize the inner products of the most expensive operation of the attention operator (e.g., attention (Q,K,V) 208 of FIG. 2).

In some cases, the one or more computing systems on which serving model 310 is to be executed may support mixture of operations on operands that may have different bit sizes (e.g., multiply-add for a mixture of INT4 (4 bits bit size representation) and INT8 (8 bits bit size representation)). In some of these cases, the one or more computing systems may compute [X_{Q}W_{Q}H]_{q}·[H^{T}W]_{q}, with p≠q, where the quantization level may be different for the activations from the quantization level applied for the parameters. In some of these cases, the one or more computing systems may compute [X_{Q}W_{Q}H]_{q}⋅[H^{T}W_{K}^{T}X_{K}^{T}]_{q}, with p≠q, where the quantization level may be different for the activations from the quantization level applied for the parameters.

### Model Analysis

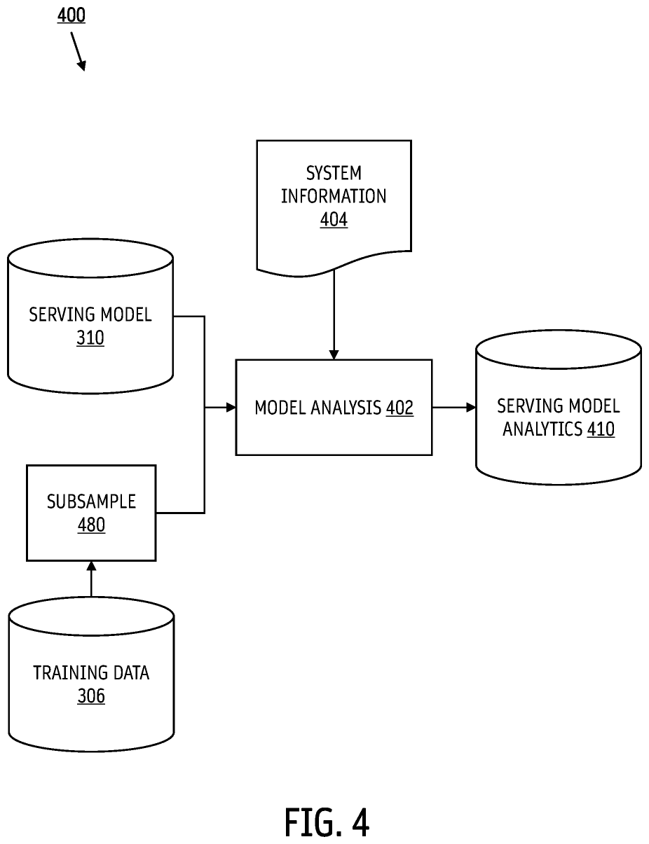

FIG. 4 illustrates exemplary operations for model analysis, according to some embodiments of the disclosure. FIG. 4 depicts components 400 (e.g., one or more components implementing one or more operations, and one or more components storing data used in the one or more operations).

In some embodiments, model analysis 402 may be used prior to deployment during model preparation stage. Model analysis 402 may gather serving model analytics 410 which may be used to help determine the one or more quantization options or the initial set of quantization options for various operations in serving model 310.

In some embodiments, model analysis 402 may be used during inference time to collect and/or accumulate analytics about serving model 310 and output the analytics as serving model analytics 410. A decision engine can use serving model analytics 410 to determine whether adaptation in quantization should be performed during inference. A decision engine can use serving model analytics 410 to produce additional quantization options for or augmentations of serving model 310 to improve the performance of the serving model 310.

Model analysis 402 may collect serving model analytics 410, such as information about how serving model 310 is behaving under different quantization options. Serving model analytics 410 may include one or more quality metrics that quantify how a quantization option may impact the performance of serving model 310. Serving model analytics 410 may include one or more inputs, one or more outputs, and one or more quantization option applied to individual operations in serving model 310. Serving model analytics 410 may include runtime performance information (e.g., how fast the serving model 310 is executing). Serving model analytics 410 may include system information 404, such as information about the one or more computing systems on which serving model 310 is executed. System information 404 may include load on the one or more computing systems on which serving model 310 is executed. System information 404 may include a number of requests for processing by serving model 310. System information 404 may include an amount of available/idle resources on the one or more computing systems on which serving model 310 is executed).

In some embodiments, model analysis 402 may collect serving model analytics 410 to analyze and/or compare the runtime performance capabilities and/or quality of serving model 310 for a set of one or more quantization options. Training data 306 available at model preparation time may be used by model analysis 402 to test the runtime performance and/or quality of serving model 310 for the set of quantization options. Training data 306 may be subsampled by subsample 480, e.g., where a subset of training data 306 may be selected at random. A subset of training data 306 may be used by model analysis 402 to gather serving model analytics 410. Model analysis 402 may select or determine one or more quantization options (e.g., drawn at random, based on best guess estimations/predictions, based on user input, etc.), and apply the one or more determined quantization options to collect initial serving model analytics 410.

Model analysis 402 may select the selected quantization option from the one or more quantization options based on best guess estimations or predictions and signal the selected quantization option to be applied to serving model 310 to gather analytics on serving model 310. Best guess estimations or predictions may include a quantization option that is suspected to yield good initial analytics, such as initial analytics that can offer information about a range of quantization options.

Model analysis 402 may select the selected quantization option from the one or more quantization options based on user input (e.g., setting, configuration, or preference) and signal the selected quantization option to be applied to serving model 310 to gather analytics on serving model 310. User input may include a quantization option specified by a user to be used to obtain good initial analytics, such as initial analytics that can offer information about a range of quantization options or initial analytics that can offer information about one or more desired quantization options.

Model analysis 402 may randomly select the selected quantization option from the one or more quantization options and signal the selected quantization option to be applied to serving model 310 to gather analytics on serving model 310.

The initial serving model analytics 410 can be used to select the most promising (e.g., best, optimal, most suitable, etc.) quantization option to initialize serving model 310 or to be applied during inference time. Model analysis 402 may determine a selected quantization option from the one or more quantization options based on one or more quality metrics derived from serving model analytics 410 quantifying a degradation impact caused by the one or more quantization options.

Model analysis 402 may collect serving model analytics 410 that includes one or more inputs and one or more outputs for individual operations in serving model 310 produced under one or more different quantization options. The outputs generated by an operation in serving model 310 under no quantization and one or more different quantization options can be compared. The comparison can be performed for one or more operations in serving model 310. Model analysis 402 can use the comparison performed at an operation in serving model 310 to measure the impact of quantization in each level and the overall impact of quantization since the input until that output.

The impact of quantization in serving model 310 used for the inference execution could be quantified based on the one or more inputs and one or more outputs for individual operations in serving model 310 produced under one or more different quantization options. Information about the impact of quantization on the quality of serving model 310 can be collected for different quantization options and for the individual operations in serving model 310. It is likely not practical to collect information for all quantization options and for all operations in serving model 310. However, model analysis 402 may (sparsely) collect samples of the information as serving model analytics 410 (e.g., collect serving model analytics 410 for a random subset of operations and/or for a random subset of quantization options), which may be used to interpolate or predict the impact of quantization on the operations of the serving model 310 under different quantization options.

For any given operation, op(cᵢₙ) operating on input cᵢₙ in serving model 310 that may be quantized, model analysis 402 may compute one or more quantities for serving model analytics 410 to derive one or more quality metrics. The quality metrics may be stored as part of serving model analytics 410. Examples of the one or more quantities for one or more operations in serving model 310 can include:
I. cₒᵤₜ=op(cᵢₙ) as computed using an operation in serving model 310 without any quantization applied. cₒᵤₜ may include a vector or a matrix.
II. cₒᵤₜ^{q}=[op(cᵢₙ)]_{q} as computed using an operation in serving model 310 with the quantization option applied to the output op(cᵢₙ) of the operation in serving model 310. (This is done on the ideal input cᵢₙ to the operation as would happen in the serving model 310.) cₒᵤₜ^{q} may include a vector or a matrix.
III. ĉₒᵤₜ^{q}=[op(cᵢₙ)]_{q} computed by using an operation in serving model 310 with, the quantization option applied to both the output op(cᵢₙ) and the input cᵢₙ^{q} of the operation in serving model 310.) cₒᵤₜ^{q} may include a vector or a matrix.

A first exemplary quality metric derivable from the quantities may quantify an impact of quantization caused by a first quantization option on a first operation of serving model 310 (e.g., the neural network model). The first exemplary quality metric may determine a quantity based on I and II (represented above). The first exemplary quality metric may include normalized quality metric can be calculated as

$$Quality ( a , b ) = \frac{a \cdot b}{‖ a ‖ \cdot ‖ b ‖} ,$$

where a=cₒᵤₜ, and b=cₒᵤₜ^{q}. The first exemplary quality metric may quantify the impact of the quantization of that specific operation op.

A second exemplary quality metric derivable from the quantities may quantify an impact of quantization caused by a first quantization option on one or more operations up to a first operation of serving model 310 (e.g., the neural network model). The second exemplary quality metric may determine a quantity based on I and III. The first exemplary quality metric may include normalized quality metric can be calculated as

$$Quality ( a , b ) = \frac{a \cdot b}{‖ a ‖ \cdot ‖ b ‖} ,$$

where a=cₒᵤₜ, and b=ĉₒᵤₜ^{q}. The second exemplary quality metric may quantify the gap of quality between the model used for inference and serving model 310 up to the specific operation op.

Model analysis 402 may determine a normalized quality metric to quantify the degradation impact due to the quantization bitrate q for a specific operation op, e.g., using the first exemplary quality metric and/or the second exemplary quality metric. In one example, the normalized quality metric can be calculated as

$$Quality ( a , b ) = \frac{a \cdot b}{‖ a ‖ \cdot ‖ b ‖} .$$

Other metrics could be used as well, such as L₂-norm/Euclidean of vectors a, b, etc.

Model analysis 402 may store the quantities I, II, and/or Ill for various operations in serving model 310 and for different quantization options as serving model analytics 410. Serving model analytics 410 may store one or more quality metrics for various operations in serving model 310 and for different quantization options as serving model analytics 410. Serving model analytics 410 may store one or more normalized quality metrics for various operations in serving model 310 and for different quantization options as serving model analytics 410.

### Short-Term Decision Engine: Short-Term Adaptation

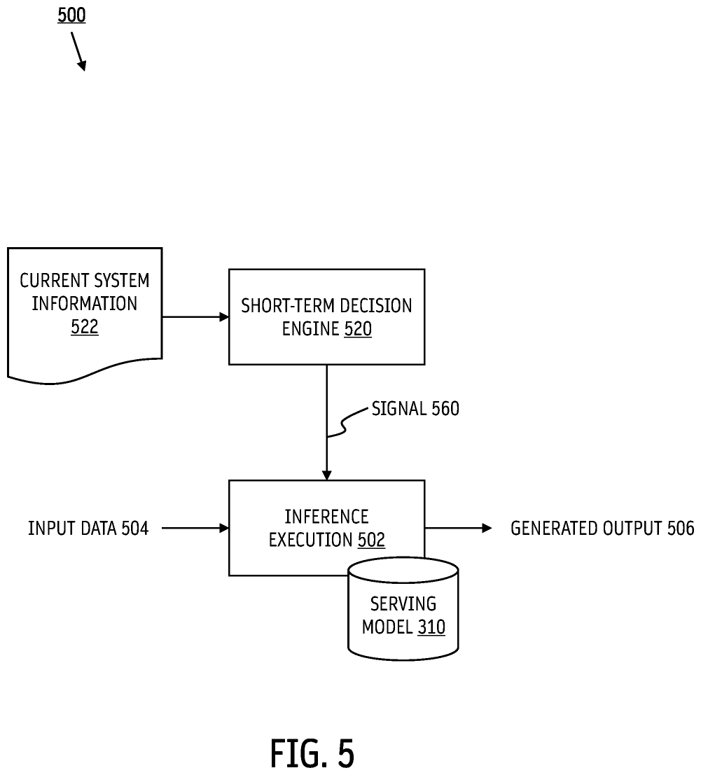

FIG. 5 illustrates exemplary operations for short-term adaptation, according to some embodiments of the disclosure. FIG. 5 depicts components 500 (e.g., one or more components implementing one or more operations, and one or more components storing data used in the one or more operations). At/during inference time, inference execution 502 (e.g., carried out by one or more computing systems) can execute serving model 310. Inference execution 502 may receive and apply input data 504 to serving model 310 and cause serving model 310 to produce generated output 506 based on input data 504.

Short-term decision engine 520 may be implemented to cause different quantization options to be applied to one or more operations in serving model 310. Short-term decision engine 520 may determine if one or more quantization options are available. If more than one quantization option is available, then short-term decision engine 520 may determine the suitable quantization option to apply for one or more operations in serving model 310. In some cases, short-term decision engine 520 may determine a selected quantization option from the one or more quantization options based on current system information 522. Current system information may include current information about the one or more computing systems. Current system information 522 may include information quantifying an amount of load or usage (e.g., a utilization level or usage percentage relative to total amount of resources) on the one or more computing systems. Current system information 522 may include information quantifying a number of requests made to or an amount of demand on the one or more computing systems. Current system information 522 may include information quantifying an amount of available resources on the one or more computing systems. In some embodiments, current system information 522 may include one or more second attributes about an execution of the neural network model by the one or more computing systems. Short-term decision engine 520 may select a quantization option (e.g., from one or more quantization options) based on one or more second attributes about the execution of the neural network model by the one or more computing systems.

In some cases, short-term decision engine 520 may determine a selected quantization option from the one or more quantization options based on user preferences (e.g., user configurations and/or settings). User preferences may be included in current system information 522. User preferences may include a minimum bitrate requirement. User preferences may include a maximum bitrate requirement. User preferences may include a maximum quality requirement. User preferences may include a minimum quality requirement. User preferences may include a bitrate range requirement. User preferences may include a (minimum or maximum) number of quantization options to consider. User preferences may include user configurations or settings. The user preferences may include preferences of one or more users associated with the one or more computing systems.

In some cases, short-term decision engine 520 may determine the selected quantization option that complements or reacts to the current information. For example, short-term decision engine 520 may determine a quantization option that may result in lower quality metrics to complement or react to a high load/demand on the one or more computing systems executing serving model 310. In another example, short-term decision engine 520 may determine a quantization option (or no quantization at all) that may result in higher quality metrics to complement or react to a low load/demand on the one or more computing systems executing serving model 310.

In some cases, short-term decision engine 520 may determine/select the selected quantization option that results in a highest amount of information loss in serving model 310 (e.g., the neural network model) relative to one or more amounts of information loss associated with the one or more other quantization options. The selected quantization option may optimize/maximize for runtime performance.

In some cases, short-term decision engine 520 may determine/select the selected quantization option that results in a lowest amount of information loss in serving model 310 (e.g., the neural network model) relative to one or more amounts of information loss associated with the one or more other quantization options. The selected quantization option may optimize/maximize for model quality.

In some cases, short-term decision engine 520 may transmit (control) signal 560 corresponding to the selected quantization option to inference execution 502 (e.g., one or more computing systems) to cause serving model 310 (e.g., the neural network model) to use one or more parameters corresponding to the selected quantization option during the inference time. In some cases, short-term decision engine 520 may transmit signal 560 corresponding to the selected quantization option to inference execution 502 (e.g., one or more computing systems) to cause serving model 310 (e.g., the neural network model) to apply the selected quantization option during the inference time. In some embodiments, short-term decision engine 520 may transmit a signal (e.g., signal 560) to the one or more computing systems to cause the one or more computing systems to use the computed parameter value for the execution of the neural network model.

Short-term decision engine 520 may transmit one or more (control) signals (e.g., signal 560) to modify the quantization option to be used for one or more operations of serving model 310. The one or more control can cause inference execution 502 to apply the selected quantization option for one or more operations of serving model 310.

In some cases, the amount of memory resources of the one or more computing systems executing serving model 310 may be enough to store parameters for more than one quantization option q. Serving model 310 may change quantization option on-the-fly (according to one or more signals, such as signal 560, from short-term decision engine 520) during inference. For example, ability to change quantization option by short-term decision engine 520 may be useful in dealing with a peak of requests in a server.

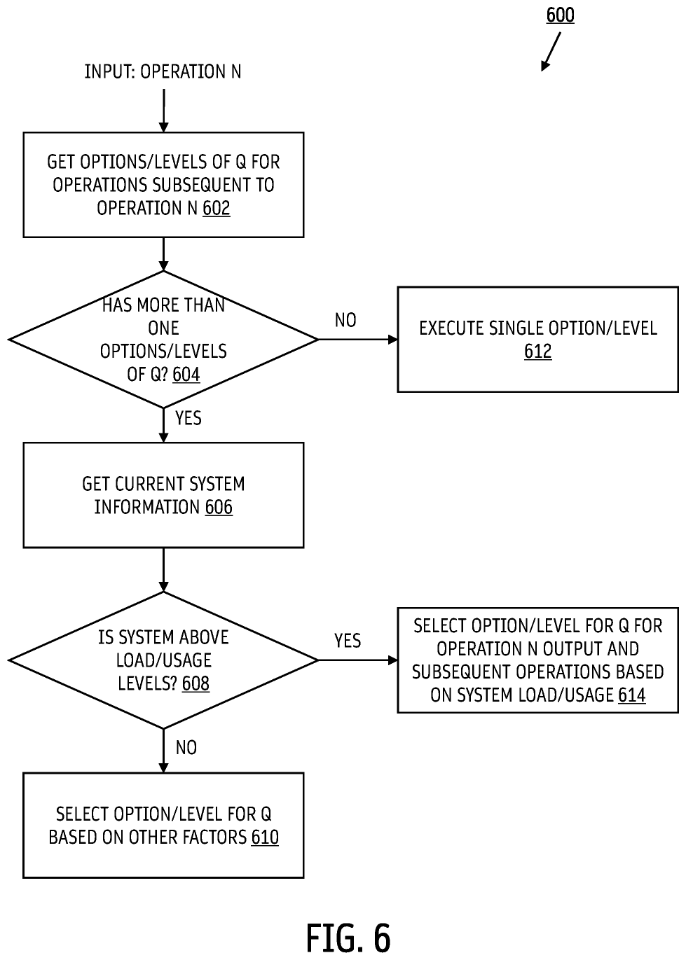

FIG. 6 illustrates an exemplary method 600 performed by a short-term decision engine (e.g., short-term decision engine 520 of FIG. 5), according to some embodiments of the disclosure. During inference time for a given operation N, the short-term decision engine 520 of FIG. 5 may decide the bitrate of the output of that operation (e.g., the quantization option) and also decide the quantization option (all) the subsequent operations that follow operation N. Short-term decision engine 520 may ensure that the bitrate of the output of operation N may match (all) the subsequent operations that follow operation N.

In 602, short-term decision engine 520 may determine or get the quantization options of q (e.g., quantization options/levels) for (all) the subsequent operations (to operation N). The options/levels of q may be common or compatible with the bitrate of the output of operation N. The options/levels of q may match the bitrate of the output of operation N.

In 604, short-term decision engine 520 may determine whether there are more than one options/levels of q for the subsequent operations.

If there is more than one option/level (e.g., YES path from 604), short-term decision engine 520 may proceed to 606.

In 606, short-term decision engine 520 may determine or get current system information (e.g., current system information 522 of FIG. 5).

If there is just one option/level (e.g., NO path from 604), short-term decision engine 520 may proceed to 612.

In 612, short-term decision engine 520 may cause the serving model (e.g., serving model 310 of the FIGS.) to execute the subsequent operations using the one single option/level of q.

In 608, short-term decision engine 520 may determine if the one or more computing system (e.g., system performing functions of inference execution 502 of the FIGS.) that is executing serving model 310 is has a load/usage that is above a certain (preferred and/or configured) load/usage level or threshold.

If the load/usage is above the certain load/usage level or threshold, short-term decision engine 520 may proceed to 614.

In 614, short-term decision engine 520 may select an available option/level of q for the computed output of operation N, e.g., based on the current system information indicating load/usage of the one or more computing system executing serving model 310. Short-term decision engine 520 may select the available option/level of q for (all) the subsequent operations to operation N. The available option/level of q may be used to quantize the computed output of operation N. The transformed/quantized parameters corresponding to the selected available option/level of q may be used by inference execution 502 when executing serving model 310.

In some cases, the selection of available option/level of q in 614 could be the smallest possible available option/level of q. This may maximize runtime performance of serving model 310 to use the lowest bitrate possible.

In some cases where the current system information indicates a mild load, the selection of available option/level of q in 614 could be a middle value of q, helping to produce better quality outputs.

If the load/usage is not above (or below) the certain load/usage level or threshold (e.g., YES path from 608), short-term decision engine 520 may proceed to 610.

In 610, short-term decision engine 520 may select an available option/level of q for the computed output of operation N, e.g., based on other factors not within the current system information.

In some cases, if there is no specific requirement to be met on the system load or usage or if the load/usage is not above (or below) the certain load/usage level or threshold (e.g., NO path from 608), short-term decision engine 520 may (always) the biggest available option/level of q (to obtain best quality outputs).

In some cases, if there is no specific requirement to be met on the system load or usage or if the load/usage is not above (or below) the certain load/usage level or threshold, short-term decision engine 520 may select randomly across the available options/level of q, every few inference executions. Random selection across the available options/level of q can increase variability and diversity of serving model analytics (e.g., serving model analytics 410 of the FIGS.) being gathered.

In some embodiments, short-term decision engine 520 may be implemented as a lightweight process to reduce or minimize the impact of short-term decision engine 520 on the one or more computing systems executing serving model 310, because short-term decision engine 520 may be implemented on the same one or more computing systems (e.g., same compute node in a cloud-based compute environment). The illustrated method 600 can be lightweight and easily supported in hardware.

In some embodiments, short-term decision engine 520 may cause inference execution 502 to use low values for q, which would improve runtime performance of the one or more computing systems. Using low values for q can decrease latency (e.g., due to smaller memory input/output to store operation results) and reduced runtime (e.g., due to vectorization of more values with same instruction widths).

### Long-Term Decision Engine: Long-Term Adaptation

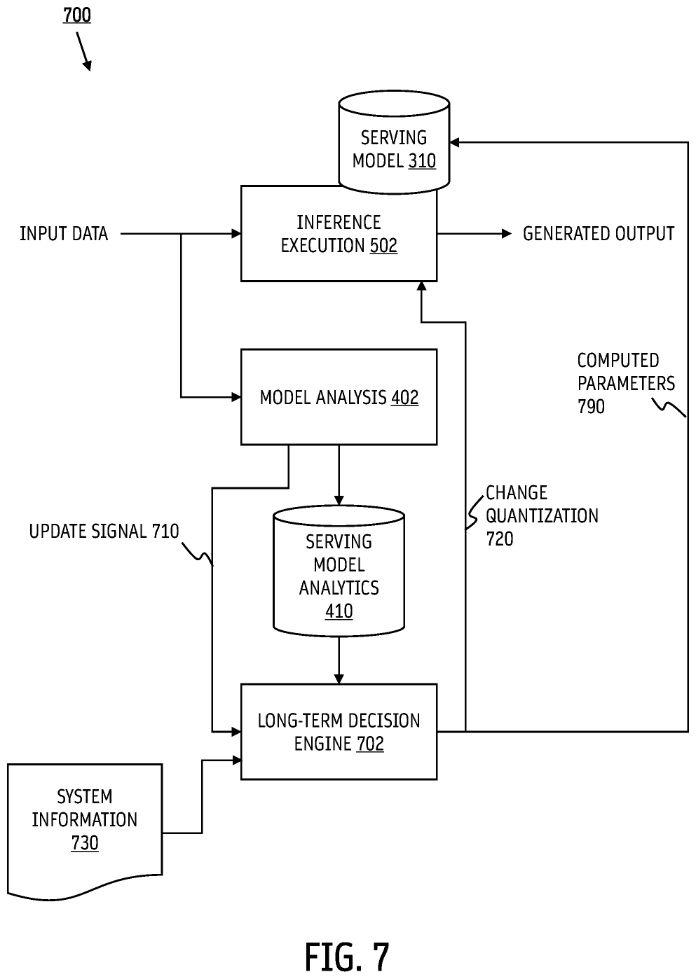

FIG. 7 illustrates exemplary operations for long-term adaptation, according to some embodiments of the disclosure. FIG. 7 depicts components 700 (e.g., one or more components implementing one or more operations, and one or more components storing data used in the one or more operations).

Before deployment and during/at inference time, model analysis 402 may be gathering serving model analytics 410.

Model analysis 402 may detect a decrease in quality of serving model 310 (e.g., the neural network model). Model analysis 402 may detect a decrease in quality based on one or more quality metrics quantifying a degradation impact caused by quantization. Model analysis 402 may detect a decrease in quality based on one or more quality metrics quantifying a degradation impact caused by a shift in one or more inputs (e.g., a shift in input distribution) provided to serving model 310 (e.g., the neural network model) during inference time.

Model analysis 402 may transmit an update signal 710 to signal a decrease in quality of serving model 310 (e.g., the neural network model) to a decision engine, such as long-term decision engine 702. In some cases, when there is a shift in input data distribution for the current quantization bitrates/options/levels being used in serving model 310, the output quality of the model may decrease (e.g., compared to serving model 310).

When the quality of serving model 310 decreases, model analysis 402 can send update signal 710 to long-term decision engine 702 to trigger quantization adaptation of serving model 310. Adaptation of quantization, if performed appropriately, can improve the quality of serving model 310.

System information 730 and/or serving model analytics 410 can be used by long-term decision engine 702 to decide where in serving model 310 (e.g., which operations in serving model 310) to reduce the quantization impact on the serving model 310. System information 730 and/or serving model analytics 410 can be used by long-term decision engine 702 to decide updated/new quantization options for serving model 310.

In response to receiving the update signal 710, long-term decision engine 702 may take information from one or more sources, e.g., serving model analytics 410 and system information 730, and determine if and how to adapt quantization being applied by inference execution 502 for operations in serving model 310. System information 730 can include static system information 308. System information 730 can include system information 404. System information 730 can include current system information 522. System information 730 can include historical system information.

In response to receiving the update signal 710, long-term decision engine 702 may transmit a change quantization signal 720 to adapt the quantization of serving model 310 (e.g., to use a different quantization option). Long-term decision engine 702 may transmit change quantization signal 720 to inference execution 502 (e.g., the one or more computing systems executing serving model 310). Change quantization signal 720 may correspond to a further quantization option. Change quantization signal 720 may cause serving model 310 (e.g., the neural network model) to use or apply one or more parameters corresponding to the further quantization option during the inference time.

In response to receiving the update signal 710, long-term decision engine 702 may determine one or more (updated) quantization options for serving model 310.

In some cases, long-term decision engine 702 may determine from system information 730 that there is a (sticky, sustained, or non-transient) shift, e.g., in a load on the one or more computing systems. Long-term decision engine 702 may determine one or more (updated) quantization options for serving model 310 that complement and/or react to the shift in the load.

In response to receiving the update signal 710, long-term decision engine 702 may compute one or more further parameters for the one or more (updated) quantization options, wherein at least one of the one or more further parameters are to be used by serving model 310 (e.g., the neural network model) during/at inference time. Long-term decision engine 702 may load or make available the one or more further parameters (illustrated as computed parameters 790) for the one or more updated quantization options into one or more memories of the one or more computing systems (e.g., the one or more computing systems carrying out model preparation 302 to execute serving model 310). Long-term decision engine 702 may transmit a change quantization signal 720 to adapt the quantization of serving model 310 to use one of the updated quantization options.

In some embodiments, long-term decision engine 702 may compute a further parameter value for the internal parameter of the neural network model using the value of the internal parameter determined from training the neural network model, wherein the further computed parameter value corresponds to a further quantization option.

In some cases, long-term decision engine 702 may not be triggered explicitly by update signal 710 (sent from model analysis 402). Long-term decision engine 702 may monitor serving model analytics 410 and/or system information 730 over time and assess whether adaptation is beneficial and/or how to perform adaptation. Long-term decision engine 702 may transmit a further (control) signal corresponding to the further quantization option to the one or more computing systems to use the further computed parameter value to execute the neural network model (e.g., during a further execution of the neural network model). Long-term decision engine 702 may load the further computed parameter value into one or more memories of the one or more computing systems.

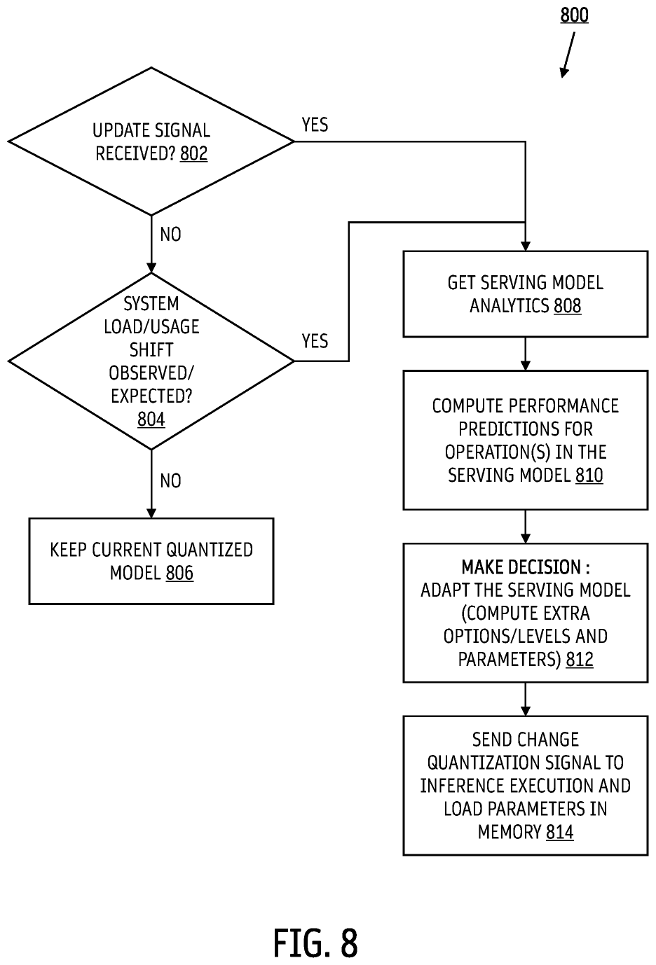

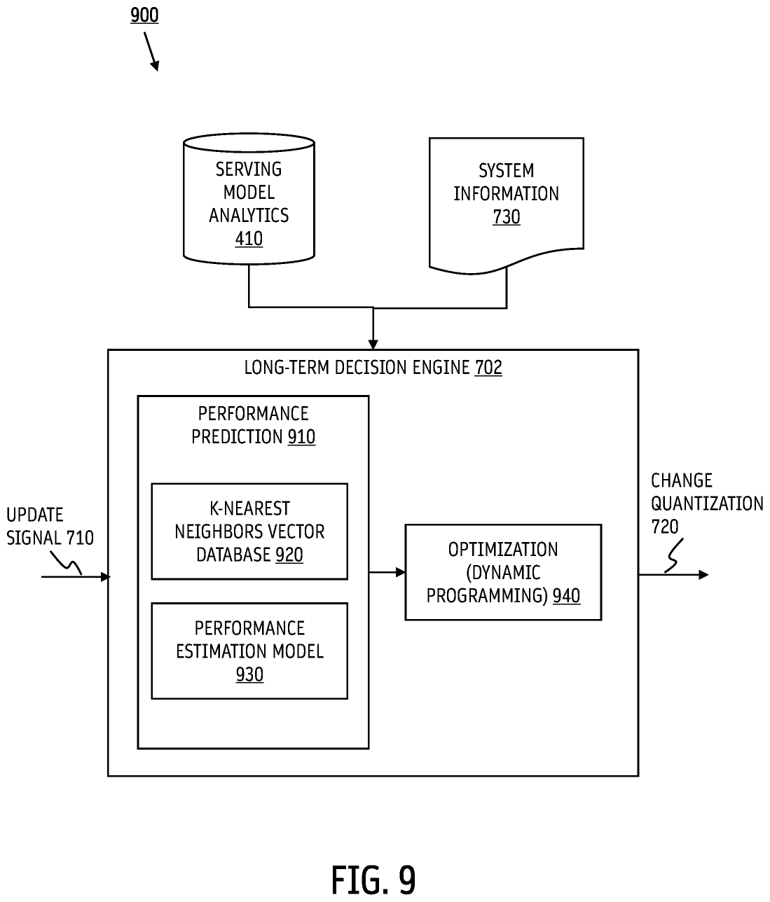

It is not trivial for long-term decision engine 702 to determine how to best adapt quantization and produce one or more updated quantization options (and corresponding precomputed parameters) for serving model 310 of the FIGS. FIGS. 8-9 illustrate exemplary mechanisms for long-term decision making for adapting serving model 310 of the FIGS.

FIG. 8 illustrates exemplary method 800 performed by a long-term decision engine (e.g., long-term decision engine 702), according to some embodiments of the disclosure.

In 802, long-term decision engine 702 may determine if an update signal (e.g., update signal 710 of FIG. 7) has been received.

If an update signal has been received (e.g., YES path from 802) long-term decision engine 702 may proceed to 808.

If an update signal has not been received (e.g., NO path from 802) long-term decision engine 702 may proceed to 804.

In 804, long-term decision engine 702 may determine if a (sustained) system load/usage shift has been observed or is expected, e.g., from system information 730 of FIG. 7.

If a system load/usage shift (e.g., a shift in utilization level) has been observed or is expected (e.g., YES path from 804), long-term decision engine 702 may proceed to 804.

If a system load/usage shift has been observed or is expected (e.g., NO path from 804), long-term decision engine 702 may proceed to 806.

In 806, long-term decision engine 702 may do nothing and keep the current quantized model, e.g., serving model 310 having a current quantization option applied. Long-term decision engine 702 may allow a short-term decision engine (short-term decision engine 520 of FIG. 5) to control quantization adaptation of serving model 310.

In 808, long-term decision engine 702 may get or obtain serving model analytics, e.g., most recent serving model analytics. Long-term decision engine 702 may query serving model analytics 410 of the FIGS. for information about how serving model 310 is behaving and/or performing. In some cases, long-term decision engine 702 may get or obtain system information 730 of FIG. 7 for information about how the one or more computing systems executing serving model 310 are behaving and/or performing.

In 810, long-term decision engine 702 may utilize collected analytics data to compute one or more performance predictions for one or more operations in serving model 310. The collected analytics data may include serving model analytics 410 and/or system information 730. The collected analytics data may include one or more collected analytics about serving model 310. Additional details regarding performance predictions are described in FIG. 9.

In 812, long-term decision engine 702 may make a quantization adaptation decision based on the one or more performance predictions. Long-term decision engine 702 may determine whether to change the quantization option being applied in serving model 310 to a different quantization option. Long-term decision engine 702 may determine one or more updated quantization options for serving model 310 based on the one or more performance predictions. Long-term decision engine 702 may compute parameters for the one or more updated quantization options. The parameters can be loaded to one or more memories of the one or more computing systems executing serving model 310 so that serving model 310 can switch to an updated quantization option with ease. Loading may include sending the parameters to the one or more memories. Loading may include causing the parameters to be stored in the one or more memories. Loading may include writing the parameters to the one or more memories. Loading may include causing the parameters to be made accessible or usable by the serving model 310.

In 814, long-term decision engine 702 may send a change quantization command (e.g., change quantization signal 720) to the one or more computing systems implementing inference execution 502 to execute serving model 310. Long-term decision engine 702 may load parameters computed for one or more updated quantization options to one or more memories of the one or more computing systems implementing inference execution 502, so that serving model 310 may switch to use the parameters precomputed for an updated quantization option.

FIG. 9 illustrates exemplary operations for a long-term decision engine 702, according to some embodiments of the disclosure. FIG. 9 depicts components 900 (e.g., one or more components implementing one or more operations, and one or more components storing data used in the one or more operations).

Long-term decision engine 702 may include performance prediction 910, which may implement one or more data-driven or machine learning models to make predictions about the performance of one or more operations in serving model 310 of the FIGS. Long-term decision engine 702 may include optimization 940, which may select or determine, based on the performance predictions produced by performance prediction 910, one or more updated quantization options that may improve the performance of serving model 310. Performance prediction 910 and optimization 940 may operate together to enable long-term decision engine 702 to make a decision about quantization adaptation of serving model 310.

In some embodiments, performance prediction 910 may include k-Nearest Neighbor (k-NN) vector database 920. Performance prediction 910 may use k-NN vector database 920 to store data such as information from serving model analytics 410 and system information 730. Performance prediction 910 may use k-NN vector database 920 to make one or more performance predictions for serving model 310. For one or more quantized versions of the serving model 310 (e.g., having one or more corresponding quantization options applied to the operations of serving model 310), performance prediction 910 may store a key-value pair, “(key, value)”, in the k-NN vector database 920. The key vector can represent an embedding of an identifier of an operation in serving model 310, performance signals, configuration constraints, system information, and system configuration. The value assigned to that key can include the possible configurations measured in the past for that operation with its associated (average) quality metrics obtained and/or runtime performance information. Then, for each operation in serving model 310 whose quantization option q is be decided or optimized, performance prediction 910 may search or identify the k-Nearest Neighbors. Performance prediction 910 may average the values of all the neighbors with the same quantization option q. Given a topological ordering of the operations in the computational graph, optimization 940 may solve an optimization problem to find the best configuration among all the quantization option q values for each operation. This optimization problem can be solved by optimization 940 via dynamic programing (e.g., controlling for system constraints) and minimizes the runtime performance (e.g., rewards lower bitrate or q), while maintaining a high enough model performance through the constraints (e.g., using the average quality metric estimation). Optimization 940 may output one or more updated quantization options. When additional serving model analytics 410 are collected, the additional serving model analytics 410 may be introduced as new (key, value) pairs into the k-NN vector database 920.

In some embodiments, performance prediction 910 may include performance estimation model 930. Performance estimation model 930 may include a neural network model. Given an operation in serving model 310, a value for quantization option q or q bitrate, and optionally other configuration information, performance estimation model 930 may output the estimated performance (e.g., runtime performance, quality metric(s)) for such operation. With the performance estimations given by performance estimation model 930 for each operation, performance estimation model 930 may make a performance prediction with each value of quantization option q or q bitrate for all operations of serving model 310. Optimization 940 may use the performance predictions to solve an optimization problem using dynamic programing (e.g., controlling for system constraints) and minimizes the runtime performance (e.g., rewards lower bitrate or q), while maintaining a high enough model performance through the constraints (e.g., using the average quality metric estimation). Optimization 940 may output one or more updated quantization options. Performance estimation model 930 may be updated/retrained by using newly collected analytics in serving model analytics 410. This update process can be implemented using lifelong learning methods. Performance estimation model 930 can be retrained to perform better with most recent information/data.

Serving model analytics 410 may include, among others, samples of the latest inputs. Performance prediction 910 may either remove old data points from the k-NN vector database 920 or by weighting the neighbors by time to ensure performance prediction 910 is operating with recent data. Performance prediction 910, when retraining the performance estimation model 930, can use a set of only latest inputs. Performance estimation model 930 may be biased towards making predictions based on the current data domain.

In some cases, the amount of memory resources of the one or more computing systems executing serving model 310 may be enough to store parameters for more than one quantization option q. Serving model 310 may change quantization option (according to (control) signals from long-term decision engine 702) during inference. For example, the ability to change quantization option by long-term decision engine 702 may be useful in persistent or sustained shift in load (or utilization level) in a server.

Based on the system configuration, long-term decision engine 702 can select the methodology and/or constraints being used to choose the additional/updated quantization options q. The method of determining one or more additional/updated quantization options (and/or constraints applied by the method) can be controlled by the user in the system configuration (e.g., included in system information 730). Some examples of different methodologies include: determining additional/updated quantization options q based on for bottleneck operations of serving model 310, determining additional/updated quantization options q based on the sequential order of execution of serving model 310, or determining a predetermined number of additional/updated quantization options q for an operation, determining at least two additional/updated quantization options q for an operations, extracting a predetermined number of additional/updated quantization options q for an operation using dynamic programming, etc.

### An Exemplary Method for Adapting Quantization of a Model During/at Inference Time

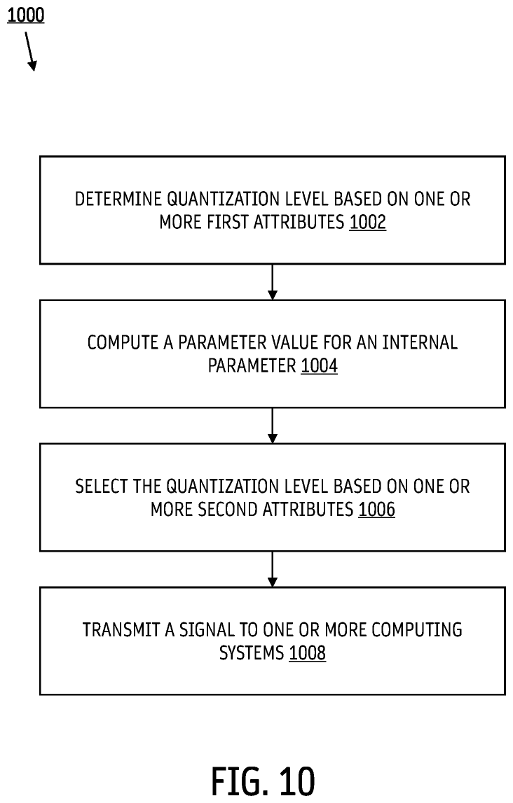

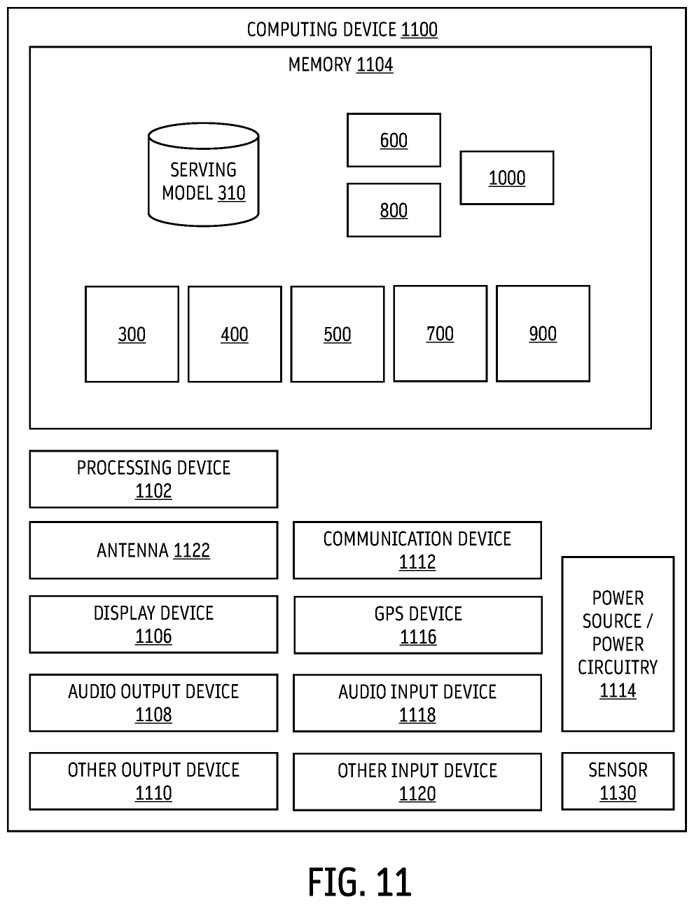

FIG. 10 is a flowchart showing a method for adaptive quantization of a model during/at inference time, according to some embodiments of the disclosure. Method 1000 can be performed using a computing device, such as computing device 1100 in FIG. 11. Method 1000 may be performed using one or more parts illustrated in FIGS. 1-5, 7 and 9. Method 1000 may be an exemplary method performed by parts as illustrated in FIGS. 1-5, 7 and 9.

In 1002, a quantization level for a neural network model may be determined based on one or more first attributes about an execution of the neural network model by one or more computing systems.

In 1004, a parameter value for an internal parameter of the neural network model may be computed using a value of the internal parameter determined from training the neural network model, wherein the computed parameter value corresponds to the quantization level.

In 1006, the quantization level may be selected based on one or more second attributes about the execution of the neural network model by the one or more computing systems.

In 1008, a (control) signal may be transmitted to the one or more computing systems to cause the one or more computing systems to use the computed parameter value to execute the neural network model.

### Exemplary Computing Device

FIG. 11 is a block diagram of an apparatus or a system, e.g., an exemplary computing device 1100, according to some embodiments of the disclosure. One or more computing devices 1100 may be used to implement the functionalities described with the FIGS. and herein. A number of components are illustrated in the FIGS. can be included in the computing device 1100, but any one or more of these components may be omitted or duplicated, as suitable for the application. In some embodiments, some or all of the components included in the computing device 1100 may be attached to one or more motherboards. In some embodiments, some or all of these components are fabricated onto a single system on a chip (SoC) die. Additionally, in various embodiments, the computing device 1100 may not include one or more of the components illustrated in FIG. 11, and the computing device 1100 may include interface circuitry for coupling to the one or more components. For example, the computing device 1100 may not include a display device 1106, and may include display device interface circuitry (e.g., a connector and driver circuitry) to which a display device 1106 may be coupled. In another set of examples, the computing device 1100 may not include an audio input device 1118 or an audio output device 1108 and may include audio input or output device interface circuitry (e.g., connectors and supporting circuitry) to which an audio input device 1118 or audio output device 1108 may be coupled.

The computing device 1100 may include a processing device 1102 (e.g., one or more processing devices, one or more of the same types of processing device, one or more of different types of processing device). The processing device 1102 may include electronic circuitry that process electronic data from data storage elements (e.g., registers, memory, resistors, capacitors, quantum bit cells) to transform that electronic data into other electronic data that may be stored in registers and/or memory. Examples of processing device 1102 may include a CPU, a GPU, a quantum processor, a machine learning processor, an artificial intelligence processor, a neural network processor, an artificial intelligence accelerator, an application specific integrated circuit (ASIC), an analog signal processor, an analog computer, a microprocessor, a digital signal processor, a field programmable gate array (FPGA), a TPU, a DPU, etc.

The computing device 1100 may include a memory 1104, which may itself include one or more memory devices such as volatile memory (e.g., DRAM), nonvolatile memory (e.g., read-only memory (ROM)), high bandwidth memory (HBM), flash memory, solid state memory, and/or a hard drive. Memory 1104 includes one or more non-transitory computer-readable storage media. In some embodiments, memory 1104 may include memory that shares a die with the processing device 1102. In some embodiments, memory 1104 includes one or more non-transitory computer-readable media storing instructions executable to perform operations described with FIGS. 1-10 and herein, such as the methods illustrated in FIGS. 6, 8, and 10. Exemplary parts, such as one or more parts of components 300, components 400, components 500, components 700, and components 900, that may be encoded as instructions and stored in memory 1104 are depicted. Memory 1104 may store instructions that encode one or more exemplary parts. The instructions stored in the one or more non-transitory computer-readable media may be executed by processing device 1102. In some embodiments, memory 1104 may store data, e.g., data structures, binary data, bits, metadata, files, blobs, etc., as described with the FIGS. and herein. Exemplary data that may be stored in memory 1104 are depicted. Memory 1104 may store one or more data as depicted.

In some embodiments, memory 1104 may store one or more machine learning models (and or parts thereof). Memory 1104 may store training data for training (trained) serving model 310, which may include one or more machine learning models. Memory 1104 may store input data, output data, intermediate outputs, intermediate inputs of one or more machine learning models. Memory 1104 may store instructions to perform one or more operations of the machine learning model. Memory 1104 may store one or more parameters used by the machine learning model. Memory 1104 may store information that encodes how processing units of the machine learning model are connected with each other.

In some embodiments, the computing device 1100 may include a communication device 1112 (e.g., one or more communication devices). For example, the communication device 1112 may be configured for managing wired and/or wireless communications for the transfer of data to and from the computing device 1100. The term “wireless” and its derivatives may be used to describe circuits, devices, systems, methods, techniques, communications channels, etc., that may communicate data through the use of modulated electromagnetic radiation through a nonsolid medium. The term does not imply that the associated devices do not contain any wires, although in some embodiments they might not. The communication device 1112 may implement any of a number of wireless standards or protocols, including but not limited to Institute for Electrical and Electronic Engineers (IEEE) standards including Wi-Fi (IEEE 802.10 family), IEEE 802.16 standards (e.g., IEEE 802.16-2005 Amendment), Long-Term Evolution (LTE) project along with any amendments, updates, and/or revisions (e.g., advanced LTE project, ultramobile broadband (UMB) project (also referred to as “3GPP2”), etc.). IEEE 802.16 compatible Broadband Wireless Access (BWA) networks are generally referred to as WiMAX networks, an acronym that stands for worldwide interoperability for microwave access, which is a certification mark for products that pass conformity and interoperability tests for the IEEE 802.16 standards. The communication device 1112 may operate in accordance with a Global System for Mobile Communication (GSM), General Packet Radio Service (GPRS), Universal Mobile Telecommunications System (UMTS), High Speed Packet Access (HSPA), Evolved HSPA (E-HSPA), or LTE network. The communication device 1112 may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). The communication device 1112 may operate in accordance with Code-division Multiple Access (CDMA), Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. The communication device 1112 may operate in accordance with other wireless protocols in other embodiments. The computing device 1100 may include an antenna 1122 to facilitate wireless communications and/or to receive other wireless communications (such as radio frequency transmissions). The computing device 1100 may include receiver circuits and/or transmitter circuits. In some embodiments, the communication device 1112 may manage wired communications, such as electrical, optical, or any other suitable communication protocols (e.g., the Ethernet). As noted above, communication device 1112 may include multiple communication chips. For instance, a first communication device 1112 may be dedicated to shorter-range wireless communications such as Wi-Fi or Bluetooth, and a second communication device 1112 may be dedicated to longer-range wireless communications such as global positioning system (GPS), EDGE, GPRS, CDMA, WiMAX, LTE, EV-DO, or others. In some embodiments, a first communication device 1112 may be dedicated to wireless communications, and a second communication device 1112 may be dedicated to wired communications.

The computing device 1100 may include power source/power circuitry 1114. The power source/power circuitry 1114 may include one or more energy storage devices (e.g., batteries or capacitors) and/or circuitry for coupling components of the computing device 1100 to an energy source separate from the computing device 1100 (e.g., DC power, AC power, etc.).

The computing device 1100 may include a display device 1106 (or corresponding interface circuitry, as discussed above). Display device 1106 may include any visual indicators, such as a heads-up display, a computer monitor, a projector, a touchscreen display, a liquid crystal display (LCD), a light-emitting diode display, or a flat panel display, for example.

The computing device 1100 may include an audio output device 1108 (or corresponding interface circuitry, as discussed above). The audio output device 1108 may include any device that generates an audible indicator, such as speakers, headsets, or earbuds, for example.

The computing device 1100 may include an audio input device 1118 (or corresponding interface circuitry, as discussed above). The audio input device 1118 may include any device that generates a signal representative of a sound, such as microphones, microphone arrays, or digital instruments (e.g., instruments having a musical instrument digital interface (MIDI) output).

The computing device 1100 may include a GPS device 1116 (or corresponding interface circuitry, as discussed above). The GPS device 1116 may be in communication with a satellite-based system and may receive a location of the computing device 1100, as known in the art.

The computing device 1100 may include a sensor 1130 (or one or more sensors). The computing device 1100 may include corresponding interface circuitry, as discussed above). Sensor 1130 may sense physical phenomenon and translate the physical phenomenon into electrical signals that can be processed by, e.g., processing device 1102. Examples of sensor 1130 may include: capacitive sensor, inductive sensor, resistive sensor, electromagnetic field sensor, light sensor, camera, imager, microphone, pressure sensor, temperature sensor, vibrational sensor, accelerometer, gyroscope, strain sensor, moisture sensor, humidity sensor, distance sensor, range sensor, time-of-flight sensor, pH sensor, particle sensor, air quality sensor, chemical sensor, gas sensor, biosensor, ultrasound sensor, a scanner, etc.

The computing device 1100 may include another output device 1110 (or corresponding interface circuitry, as discussed above). Examples of the other output device 1110 may include an audio codec, a video codec, a printer, a wired or wireless transmitter for providing information to other devices, haptic output device, gas output device, vibrational output device, lighting output device, home automation controller, or an additional storage device.

The computing device 1100 may include another input device 1120 (or corresponding interface circuitry, as discussed above). Examples of the other input device 1120 may include an accelerometer, a gyroscope, a compass, an image capture device, a keyboard, a cursor control device such as a mouse, a stylus, a touchpad, a bar code reader, a Quick Response (QR) code reader, any sensor, or a radio frequency identification (RFID) reader.

The computing device 1100 may have any desired form factor, such as a handheld or mobile computer system (e.g., a cell phone, a smart phone, a mobile internet device, a music player, a tablet computer, a laptop computer, a netbook computer, a personal digital assistant (PDA), a personal computer, a remote control, wearable device, headgear, eyewear, footwear, electronic clothing, etc.), a desktop computer system, a server or other networked computing component, a printer, a scanner, a monitor, a set-top box, an entertainment control unit, a vehicle control unit, a digital camera, a digital video recorder, an Internet-of-Things device, or a wearable computer system. In some embodiments, the computing device 1100 may be any other electronic device that processes data.

### Exemplary Computing System

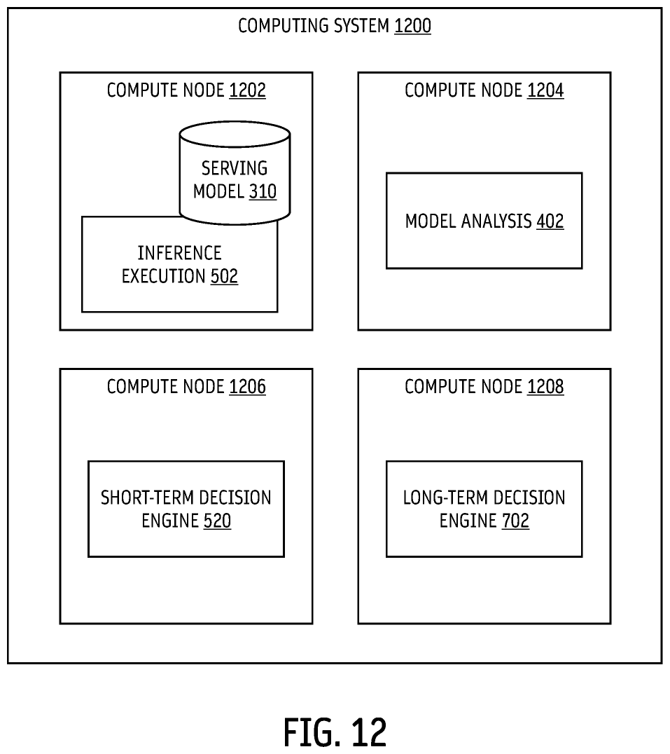

FIG. 12 is a block diagram of an exemplary computing system 1200, according to some embodiments of the disclosure. Computing system 1200 may include one or more compute nodes 1202 having inference execution 502 and serving model 310 implemented thereon. Computing system 1200 may include one or more compute nodes 1204 having model analysis 402 implemented thereon. Computing system 1200 may include one or more compute nodes 1206 having model analysis short-term decision engine 520 implemented thereon. Computing system 1200 may include one or more compute nodes 1208 having model analysis long-term decision engine 702 implemented thereon.

One or more compute nodes 1202 may include one or more computing devices, such as computing device 1100 of FIG. 1. One or more compute nodes 1204 may include one or more computing devices, such as computing device 1100 of FIG. 1. One or more compute nodes 1206 may include one or more computing devices, such as computing device 1100 of FIG. 1. One or more compute nodes 1208 may include one or more computing devices, such as computing device 1100 of FIG. 1. In some cases, one or more compute nodes may be synonymous with one or more computing systems.

In some embodiments, one or more compute nodes of computing system 1200 may be interconnected over a network in a cloud environment. In other words, computing system 1200 may include interconnected sets of cloud-based resources. In some cases, two or more compute nodes of computing system 1200, even when containerized, may share a same pool of resources. In some cases, two or more compute nodes of computing system 1200 may not share the same pool of resources and may have respective (independent) pools of resources.

A compute node may include a containerized or a set of resources in a cloud environment having many resources.

A compute node may include a set of resources in a single server, e.g., a processor core or computing sub-system of the server.

In some embodiments, one or more compute nodes of computing system 1200 may be interconnected over an interconnect bus/network in a single server. One or more compute nodes of computing system 1200 may include computing sub-systems of a single server. In other words, computing system 1200 may include a server or computer.

As illustrated, various components are shown to be implemented on one or more separate compute nodes, but it is envisioned by the disclosure that at least some of the components may be implemented on the same compute node.

In some embodiments, model analysis 402 may perform its operations to collect serving model analytics 410 when the system load is low enough, e.g., using idle cycles and freed memory of the one or more compute nodes 1202 on which serving model 310 is executed. In such a case, model analysis 402, inference execution 502, and serving model 310 may be implemented on the same compute nodes such as one or more compute nodes 1202.

In some embodiments, model analysis 402 may be implemented in one or more compute nodes (e.g., one or more compute nodes 1204) separate from the one or more compute nodes (e.g., one or more compute nodes 1202) on which serving model 310 and inference execution 502 are executed to avoid negatively impacting the runtime performance of serving model 310, as illustrated in FIG. 12.

In some embodiments, long-term decision engine 702 may be running in more than one compute node in a cloud-based compute environment (one or more compute nodes 1208 may include more than one compute node). Running long-term decision engine 702 on more than one compute node can ensure long-term decision engine 702 has enough compute resources to determine one or more updated quantization options (and corresponding parameters) and modify serving model 310.

In some embodiments, long-term decision engine 702 may be running in one or more compute nodes 1208 that are separate from the one or more compute nodes 1202 performing inference execution 502 of serving model 310. Running long-term decision engine 702 on separate nodes can reduce or minimize the influence of long-term decision engine 702 on inference execution 502 of serving model 310. Running long-term decision engine 702 on separate nodes or one or more compute nodes can ensure long-term decision engine 702 has enough compute resources to determine one or more updated quantization options (and corresponding parameters) and modify serving model 310. For example, the retraining of the performance estimation model 930 can be executed in a separate/dedicated compute node in one or more compute nodes 1208 that has one or more hardware accelerators for training neural network models.

### Exemplary Machine Learning Models and Parts Thereof

The serving model described herein may be implemented using one or more machine learning models, e.g., using one or more deep learning models, or one or more neural network models.

An execution of a machine learning model, e.g., the serving model, a neural network model, etc., comprises the process of performing operations in the machine learning model. The operations may be performed for making one or more inferences about input data. The operations may be performed for performing a task (e.g., generating embeddings, output predictions, and/or inferences about the input data). The operations may be performed for training the machine learning model.

A machine learning model refers to computer-implemented systems that can perform one or more tasks. A machine learning model can take an input and generate an output for the task at hand. Using and implementing a machine learning model may involve supervised learning, unsupervised learning, semi-supervised learning, and reinforcement learning. A machine learning model can be implemented in different ways. A machine learning model can include one or more of: an artificial neural network, a deep learning model, a decision tree, a support vector machine, regression analysis, a Bayesian network, a Gaussian process, a genetic algorithm, etc.

An artificial neural network (or neural network model) may include one or more layers, modules, networks, blocks and/or operator that transform the input into an output. In some embodiments, a layer, module, network, block and/or operator may include one or more processing units and/or one or more processing nodes. A processing unit may receive one or more inputs, perform a processing function or operation, and generate one or more outputs. Processing units may be interconnected to form a network. In some cases, the processing units or nodes may be referred to as neurons. An example is illustrated as neuron 102 of FIG. 1. Different types of processing units or nodes may be distinguished by the processing function/operation that is being performed by the processing units or nodes. A processing unit may include one or more parameters. The parameters may be trained or learned. A processing unit may include one or more hyperparameters. Hyperparameters may be set or tuned, adjusted, or set by one or more users of the machine learning model.

One type of processing unit is a convolution block and/or operator. The processing unit applies a convolution operation to the input and generates an output. The convolution operation may extract features from the input and output the features as the output. The convolution operation may transform the input and generate an output. The processing unit may convolve the input with a kernel to generate an output. A kernel may include a matrix. The kernel may encode a function or operation that can transform the input. The kernel may include values or parameters that can be trained or learned. The processing unit may compute inner products (e.g., dot products) with a sliding/moving window capturing local regions or patches of the input and sum and/or accumulate the inner products to generate an output. Inner products may be computed successively across the input matrix, as the sliding/moving windows move across the input matrix. A convolution block and/or operator may be defined by the size of the kernel, e.g., a 1×1 convolution (a convolutional operator having a kernel size of 1×1), a 2×2 convolution (a convolutional operator having a kernel size of 2×2), a 3×3 convolution (a convolutional operator having a kernel size of 3×3), a 4×4 convolution (a convolutional operator having a kernel size of 4×4), a 5×5 convolution (a convolutional operator having a kernel size of 5×5), and so forth. The distance the window slides/moves can be set or defined by the stride of the convolution operator. In some cases, the convolution block and/or operator may apply no padding and uses the input matrix as-is. In some cases, the convolution block and/or operator may apply half padding and pads around a part of the input matrix. In some cases, the convolution block and/or operator may apply full padding and pads around the input matrix. In some cases, the convolution block and/or operator may be defined by a dimension of the filter being applied. For example, a 1-D convolution block and/or operator may apply a sliding convolution filter or kernel of size k (a hyperparameter) to one-dimensional input. Values in the sliding convolution filter or kernel can be trained and/or learned.

An exemplary layer, module, block and/or operator may include a dilation convolution block may increase can extract features at various scales. A dilation convolution block may expand the kernel by inserting gaps between the weights in the kernel. A dilation convolution module may have a dilation rate or dilation factor which indicates how much the kernel is widened. Parameters in the kernel can be trained or learned.

Another type of processing unit is a transformer node. An example is illustrated as transformer-based node 202 of FIG. 2. A transformer node may be used in a transformer block. A transformer node may implement an attention mechanism to extract dependencies between different parts of the input to the transformer node. A transformer node may receive an input and generate an output that represents the significance or attention of various parts of the input. A transformer node may include query weights, key weights, and value weights as parameters that can be trained or learned. A transformer node may apply the parameters to extract relational information between different parts of the input to the transformer node.

Another type of processing unit is an activation unit or block. An activation block may implement or apply an activation function (e.g., a sigmoid function, a non-linear function, hyperbolic tangent function, rectified linear unit, leaky rectified linear unit, parametric rectified linear unit, sigmoid linear unit, exponential linear unit, scaled exponential linear function, logistic activation function, Heaviside activation function, identity function, binary step function, soft step function, Gaussian error linear unit, Gaussian function, softplus function, etc.) to an input to the activation block and generate an output. An activation block can be used to map an input to the block to a value between 0 and 1. An activation block can be used to map an input to the block to a zero (0) or a one (1). An activation block can introduce non-linearity. An activation block can learn complex decision boundaries. One or more parameters of the activation function can be trained or learned.

An exemplary layer, module, block, or operator may include an upsampling block. An upsampling block may increase the size of the input features or feature maps. An upsampling block may synthesize values that can be added to the input features or feature maps to increase the size and output features or feature maps that are upsampled.

An exemplary layer, module, block, or operator may include a downsampling block. A downsampling block may perform downsampling of features or feature maps generated by the stages, which may improve running efficiency of machine learning model. A downsampling block may include a pooling layer, which may receive feature maps at its input and applies a pooling operation to the feature maps. The output of the pooling layer can be provided or inputted into a subsequent stage for further processing. The pooling operation can reduce the size of the feature maps while preserving their (important) characteristics. Accordingly, the pooling operation may improve the efficiency of the overall model and can avoid over-learning. A pooling layer may perform the pooling operation through average pooling (calculating the average value for each patch on the feature map), max pooling (calculating the maximum value for each patch of the feature map), or a combination of both. The size of an output of a pooling layer is smaller than the size of the feature maps provided as input to the pooling layer. In some embodiments, the pooling operation is 2×2 pixels applied with a stride of 2 pixels, so that the pooling operation reduces the size of a feature map by a factor of 2, e.g., the number of pixels or values in the feature map is reduced to one quarter the size. In some embodiments, a pooling layer applied to a feature map of 6×6 results in an output pooled feature map of 3×3.

An exemplary layer, module, block, or operator may include a projection layer (sometimes referred to as a 1×1 convolution block and/or operator). A projection layer may transform input features into a new space, such as a space that is suitable, informative, and/or useful for tasks being performed by modules downstream (for processing by modules downstream). A projection layer may include a dense layer, or a fully connected layer where each neuron (e.g., a node or processing unit in a neural network) is connected to every neuron of the previous layer. A projection layer may generate and/or output one or more new features (e.g., a new set of features) that are more abstract or high-level than features in the input. A projection layer may implement one or more 1×1 convolution operations, where the projection layer may convolve the input features with filters of size 1×1 (e.g., with zero-padding and a stride of 1). A projection layer may implement channel-wise pooling or feature map pooling. A projection layer may reduce dimensionality of the input features by pooling features across channels. A projection layer may implement a 1×1 filter to create a linear projection of a stack of feature maps. A projection layer may implement a 1×1 filter to increase the number of feature maps. A projection layer may implement a 1×1 filter to decrease the number of channels. A projection layer may make the feature maps compatible with subsequent processing layers, modules, blocks, or operators. A projection layer may ensure that an element-wise adding operation can be performed to add the output of the projection layer and another feature map. A projection layer can ensure the dimensionality of the output of the projection layer matches the dimensionality of the feature map being element-wise added together. Parameters of the projection layer can be trained or learned.

An exemplary block may include an adder block. An adder block may perform element-wise adding of two or more inputs to generate an output. An adder block can be an exemplary block that can merge and/or combine two or more inputs together. Adding and summing may be synonymous. An adder block may be replaced by a concatenate block.

An exemplary block may include a multiplier block. A multiplier block may perform element-wise multiplication of two or more inputs to generate an output. A multiplier block may determine a Hadamard product.

An exemplary block may include a concatenate block. A concatenate block may perform concatenation of two or more inputs to generate an output. A concatenate block may append vectors and/or matrices in the inputs to form a new vector and/or matrix. Vector concatenation can be appended to form a larger vector. Matrix concatenation can be performed horizontally, vertically, or in a merged fashion. Horizontal matrix concatenation can be performed by concatenating matrices (that have the same height) in the inputs width-wise. Vertical matrix concatenation can be performed by concatenating matrices (that have the same width) in the inputs height-wise. A concatenate block can be an exemplary block that can merge and/or combine two or more inputs together. A concatenate block may be suitable when the two or more inputs do not have the same dimensions. A concatenate block may be suitable when it is desirable to keep the two or more inputs unchanged or intact (e.g., to not lose information). A concatenate block may be replaced by an adder block.

### SELECT EXAMPLES

Example 1 provides a method, including determining a quantization level for a neural network model based on one or more first attributes about an execution of the neural network model by one or more computing systems; computing a parameter value for an internal parameter of the neural network model using a value of the internal parameter determined from training the neural network model, where the computed parameter value corresponds to the quantization level; selecting the quantization level based on one or more second attributes about the execution of the neural network model by the one or more computing systems; and transmitting a signal to the one or more computing systems to cause the one or more computing systems to use the computed parameter value to execute the neural network model.

Example 2 provides the method of example 1, where the execution of the neural network model includes the neural network model performing inference on input data.

Example 3 provides the method of example 1 or 2, where the one or more first attributes include one or more preferences of one or more users associated with the one or more computing systems.

Example 4 provides the method of any one of examples 1-3, where the one or more first attributes include one or more of: an amount of compute resources assigned to the execution of the neural network model, and one or more types of compute resources assigned to the execution of the neural network model.

Example 5 provides the method of any one of examples 1-4, where the one or more first attributes include one or more of: an amount of memory resources assigned to the execution of the neural network model, and one or more types of assigned memory resources assigned to the execution of the neural network model.

Example 6 provides the method of any one of examples 1-5, where the one or more first attributes include a number of operations in the neural network model.

Example 7 provides the method of any one of examples 1-6, where computing the parameter value includes applying a Hadamard transform to the value of the internal parameter to obtain a transformed parameter.

Example 8 provides the method of example 7, where computing the parameter value includes quantizing the transformed parameter according to the quantization level.

Example 9 provides the method of any one of examples 1-8, further including loading the computed parameter value into one or more memories of the one or more computing systems.

Example 10 provides the method of any one of examples 1-9, where the one or more second attributes include a level of utilization of the one or more computing systems.

Example 11 provides the method of any one of examples 1-10, where selecting the quantization level includes selecting the quantization level from one or more quantization levels at random.

Example 12 provides the method of any one of examples 1-10, where selecting the quantization level includes determining the selected quantization level that results in a highest amount of information loss in the neural network model relative to one or more amounts of information loss of one or more other quantization levels.

Example 13 provides the method of any one of examples 1-10, where selecting the quantization level includes determining the selected quantization level that results in a lowest amount of information loss in the neural network model relative to one or more amounts of information loss of one or more other quantization levels.

Example 14 provides the method of any one of examples 1-13, further including measuring a first quality metric quantifying an impact of quantization caused by a first available quantization level on a first operation of the neural network model.

Example 15 provides the method of any one of examples 1-14, further including measuring a second quality metric quantifying an impact of quantization caused by a first available quantization level on one or more operations up to a first operation of the neural network model.

Example 16 provides the method of any one of examples 1-15, where selecting the quantization level includes selecting the quantization level further based on one or more quality metrics quantifying a degradation impact caused by the quantization level.

Example 17 provides the method of any one of examples 1-16, further including transmitting an update signal to signal a decrease in quality of the neural network model to a decision engine.

Example 18 provides the method of any one of examples 1-17, further including computing a further parameter value for the internal parameter of the neural network model using the value of the internal parameter determined from training the neural network model, where the further computed parameter value corresponds to a further quantization level; and transmitting a further signal corresponding to the further quantization level to the one or more computing systems to use the further computed parameter value to execute the neural network model.

Example 19 provides the method of example 18, further including loading the further computed parameter value into one or more memories of the one or more computing systems.

Example 20 provides the method of example 18 or 19, further including determining the further quantization level based on one or more performance predictions of the neural network model.

Example 21 provides the method of example 20, where the one or more performance predictions are generated based on one or more collected analytics about the neural network model.

Example 22 provides the method of any one of examples 1-21, further including determining a shift in a utilization level of the one or more computing systems; and determining an updated quantization level based on the shift in the utilization level.

Example 23 provides one or more non-transitory computer-readable media storing instructions that, when executed by one or more processors, cause the one or more processors to: determine a quantization level for a neural network model based on one or more first attributes about an execution of the neural network model by one or more computing systems; compute a parameter value for an internal parameter of the neural network model using a value of the internal parameter determined from training the neural network model, where the computed parameter value corresponds to the quantization level; select the quantization level based on one or more second attributes about the execution of the neural network model by the one or more computing systems; and transmit a control signal to the one or more computing systems to cause the one or more computing systems to use the computed parameter value for the execution of the neural network model.

Example 24 provides the one or more non-transitory computer-readable media of example 23, where the execution of the neural network model includes the neural network model performing inference on input data.

Example 25 provides the one or more non-transitory computer-readable media of example 23 or 24, where the one or more first attributes include one or more preferences of one or more users associated with the one or more computing systems.

Example 26 provides the one or more non-transitory computer-readable media of any one of examples 23-25, where the one or more first attributes include one or more of: an amount of compute resources assigned to the execution of the neural network model, and one or more types of compute resources assigned to the execution of the neural network model.

Example 27 provides the one or more non-transitory computer-readable media of any one of examples 23-26, where the one or more first attributes include one or more of: an amount of memory resources assigned to the execution of the neural network model, and one or more types of assigned memory resources assigned to the execution of the neural network model.

Example 28 provides the one or more non-transitory computer-readable media of any one of examples 23-27, where the one or more first attributes include a number of operations in the neural network model.

Example 29 provides the one or more non-transitory computer-readable media of any one of examples 23-28, where computing the parameter value includes applying a Hadamard transform to the value of the internal parameter to obtain a transformed parameter.

Example 30 provides the one or more non-transitory computer-readable media of example 29, where computing the parameter value includes quantizing the transformed parameter according to the quantization level.

Example 31 provides the one or more non-transitory computer-readable media of any one of examples 23-30, where the instructions further cause the one or more processors to: load the computed parameter value into one or more memories of the one or more computing systems.

Example 32 provides the one or more non-transitory computer-readable media of any one of examples 23-31, where the one or more second attributes include a level of utilization of the one or more computing systems.

Example 33 provides the one or more non-transitory computer-readable media of any one of examples 23-32, where selecting the quantization level includes selecting the quantization level from one or more quantization levels at random.

Example 34 provides the one or more non-transitory computer-readable media of any one of examples 23-33, where selecting the quantization level includes determining the selected quantization level that results in a highest amount of information loss in the neural network model relative to one or more amounts of information loss of one or more other quantization levels.

Example 35 provides the one or more non-transitory computer-readable media of any one of examples 23-34, where selecting the quantization level includes determining the selected quantization level that results in a lowest amount of information loss in the neural network model relative to one or more amounts of information loss of one or more other quantization levels.

Example 36 provides the one or more non-transitory computer-readable media of any one of examples 23-35, where the instructions further cause the one or more processors to: measure a first quality metric quantifying an impact of quantization caused by a first available quantization level on a first operation of the neural network model.

Example 37 provides the one or more non-transitory computer-readable media of any one of examples 23-36, where the instructions further cause the one or more processors to: measure a second quality metric quantifying an impact of quantization caused by a first available quantization level on one or more operations up to a first operation of the neural network model.

Example 38 provides the one or more non-transitory computer-readable media of any one of examples 23-37, where selecting the quantization level includes selecting the quantization level further based on one or more quality metrics quantifying a degradation impact caused by the quantization level.

Example 39 provides the one or more non-transitory computer-readable media of any one of examples 23-38, where the instructions further cause the one or more processors to: transmit an update signal to signal a decrease in quality of the neural network model to a decision engine.

Example 40 provides the one or more non-transitory computer-readable media of any one of examples 23-39, where the instructions further cause the one or more processors to: compute a further parameter value for the internal parameter of the neural network model using the value of the internal parameter determined from training the neural network model, where the further computed parameter value corresponds to a further quantization level; and transmit a further signal corresponding to the further quantization level to the one or more computing systems to use the further computed parameter value to execute the neural network model.

Example 41 provides the one or more non-transitory computer-readable media of example 40, where the instructions further cause the one or more processors to: load the further computed parameter value into one or more memories of the one or more computing systems.

Example 42 provides the one or more non-transitory computer-readable media of example 40 or 41, where the instructions further cause the one or more processors to: determining the further quantization level based on one or more performance predictions of the neural network model.

Example 43 provides the one or more non-transitory computer-readable media of example 42, where the one or more performance predictions are generated based on one or more collected analytics about the neural network model.

Example 44 provides the one or more non-transitory computer-readable media of any one of examples 23-43, where the instructions further cause the one or more processors to: determine a shift in a utilization level of the one or more computing systems; and determine an updated quantization level based on the shift in the utilization level.

Example 45 provides a system, including one or more first processors for executing first instructions; and a non-transitory computer-readable memory storing the first instructions, the instructions causing the one or more processors to: determine a quantization level for a neural network model based on one or more first attributes about an execution of the neural network model by one or more computing systems; compute a parameter value for an internal parameter of the neural network model using a value of the internal parameter determined from training the neural network model, where the computed parameter value corresponds to the quantization level; select the quantization level based on one or more second attributes about the execution of the neural network model by the one or more computing systems; and transmit a signal to the one or more computing systems to cause the one or more computing systems to use the computed parameter value to execute the neural network model.

Example 46 provides the system of example 45, where the execution of the neural network model includes the neural network model performing inference on input data.

Example 47 provides the system of example 45 or 46, where the one or more first attributes include one or more preferences of one or more users associated with the one or more computing systems.

Example 48 provides the system of any one of examples 45-47, where the one or more first attributes include one or more of: an amount of compute resources assigned to the execution of the neural network model, and one or more types of compute resources assigned to the execution of the neural network model.

Example 49 provides the system of any one of examples 45-48, where the one or more first attributes include one or more of: an amount of memory resources assigned to the execution of the neural network model, and one or more types of assigned memory resources assigned to the execution of the neural network model.

Example 50 provides the system of any one of examples 45-49, where the one or more first attributes include a number of operations in the neural network model.

Example 51 provides the system of any one of examples 45-50, where computing the parameter value includes applying a Hadamard transform to the value of the internal parameter to obtain a transformed parameter.

Example 52 provides the system of example 51, where computing the parameter value includes quantizing the transformed parameter according to the quantization level.

Example 53 provides the system of any one of examples 45-52, where the instructions further cause the one or more processors to: load the computed parameter value into one or more memories of the one or more computing systems.

Example 54 provides the system of any one of examples 45-53, where the one or more second attributes include a level of utilization of the one or more computing systems.

Example 55 provides the system of any one of examples 45-54, where selecting the quantization level includes selecting the quantization level from one or more quantization levels at random.

Example 56 provides the system of any one of examples 45-55, where selecting the quantization level includes determining the selected quantization level that results in a highest amount of information loss in the neural network model relative to one or more amounts of information loss of one or more other quantization levels.

Example 57 provides the system of any one of examples 45-56, where selecting the quantization level includes determining the selected quantization level that results in a lowest amount of information loss in the neural network model relative to one or more amounts of information loss of one or more other quantization levels.

Example 58 provides the system of any one of examples 45-57, where the instructions further cause the one or more processors to: measure a first quality metric quantifying an impact of quantization caused by a first available quantization level on a first operation of the neural network model.

Example 59 provides the system of any one of examples 45-58, where the instructions further cause the one or more processors to: measure a second quality metric quantifying an impact of quantization caused by a first available quantization level on one or more operations up to a first operation of the neural network model.

Example 60 provides the system of any one of examples 45-59, where selecting the quantization level includes selecting the quantization level further based on one or more quality metrics quantifying a degradation impact caused by the quantization level.

Example 61 provides the system of any one of examples 45-60, where the instructions further cause the one or more processors to: transmit an update signal to signal a decrease in quality of the neural network model to a decision engine.

Example 62 provides the system of any one of examples 45-61, where the instructions further cause the one or more processors to: compute a further parameter value for the internal parameter of the neural network model using the value of the internal parameter determined from training the neural network model, where the further computed parameter value corresponds to a further quantization level; and transmit a further signal corresponding to the further quantization level to the one or more computing systems to use the further computed parameter value to execute the neural network model.

Example 63 provides the system of example 62, where the instructions further cause the one or more processors to: load the further computed parameter value into one or more memories of the one or more computing systems.

Example 64 provides the system of example 62 or 63, where the instructions further cause the one or more processors to: determining the further quantization level based on one or more performance predictions of the neural network model.

Example 65 provides the system of example 64, where the one or more performance predictions are generated based on one or more collected analytics about the neural network model.

Example 66 provides the system of any one of examples 45-65, where the instructions further cause the one or more processors to: determine a shift in a utilization level of the one or more computing systems; and determine an updated quantization level based on the shift in the utilization level.

Example A provides an apparatus comprising means to carry out or means for carrying out any one of the computer-implemented methods provided in examples 1-22.

Example A provides an apparatus comprising means to carry out or means for carrying out any one of the methods provided in examples 1-22.

Example B provides a computer-implemented system comprising one or more components illustrated in the FIGS. (e.g., FIGS. 1-5, 7-9, and 11-12) to perform operations described herein.

Example C provides one or more non-transitory computer-readable media storing instructions that, when executed by one or more processors, cause the one or more processors to perform any one of the methods illustrated in FIGS. 6, 8, and 10.

Example D provides an apparatus comprising means to carry out or means for carrying out any one of the methods illustrated in FIGS. 6, 8, and 10.

Example E provides a system, comprising one or more processors, and one or more non-transitory computer-readable media storing instructions that, when executed by the one or more processors, cause the one or more processors to perform any one of the methods illustrated in FIGS. 6, 8, and 10.

Example F provides a computing system comprising one or more compute nodes as illustrated in FIG. 12.

### VARIATIONS AND OTHER NOTES

Although the operations of the example method shown in and described with reference to FIGS. 6, 8, and 10 are illustrated as occurring once each and in a particular order, it will be recognized that the operations may be performed in any suitable order and repeated as desired. Additionally, one or more operations may be performed in parallel. Furthermore, the operations illustrated in FIGS. 6, 8, and 10 may be combined or may include more or fewer details than described.

The above description of illustrated implementations of the disclosure, including what is described in the Abstract, is not intended to be exhaustive or to limit the disclosure to the precise forms disclosed. While specific implementations of, and examples for, the disclosure are described herein for illustrative purposes, various equivalent modifications are possible within the scope of the disclosure, as those skilled in the relevant art will recognize. These modifications may be made to the disclosure in light of the above detailed description.

For purposes of explanation, specific numbers, materials and configurations are set forth in order to provide a thorough understanding of the illustrative implementations. However, it will be apparent to one skilled in the art that the present disclosure may be practiced without the specific details and/or that the present disclosure may be practiced with only some of the described aspects. In other instances, well known features are omitted or simplified in order not to obscure the illustrative implementations.

Further, references are made to the accompanying drawings that form a part hereof, and in which are shown, by way of illustration, embodiments that may be practiced. It is to be understood that other embodiments may be utilized, and structural or logical changes may be made without departing from the scope of the present disclosure. Therefore, the following detailed description is not to be taken in a limiting sense.

Various operations may be described as multiple discrete actions or operations in turn, in a manner that is most helpful in understanding the disclosed subject matter. However, the order of description should not be construed as to imply that these operations are necessarily order dependent. In particular, these operations may not be performed in the order of presentation. Operations described may be performed in a different order from the described embodiment. Various additional operations may be performed or described operations may be omitted in additional embodiments.

For the purposes of the present disclosure, the phrase “A or B” or the phrase “A and/or B” means (A), (B), or (A and B). For the purposes of the present disclosure, the phrase “A, B, or C” or the phrase “A, B, and/or C” means (A), (B), (C), (A and B), (A and C), (B and C), or (A, B, and C). The term “between,” when used with reference to measurement ranges, is inclusive of the ends of the measurement ranges.

The description uses the phrases “in an embodiment” or “in embodiments,” which may each refer to one or more of the same or different embodiments. The terms “comprising,” “including,” “having,” and the like, as used with respect to embodiments of the present disclosure, are synonymous. The disclosure may use perspective-based descriptions such as “above,” “below,” “top,” “bottom,” and “side” to explain various features of the drawings, but these terms are simply for ease of discussion, and do not imply a desired or required orientation. The accompanying drawings are not necessarily drawn to scale. Unless otherwise specified, the use of the ordinal adjectives “first,” “second,” and “third,” etc., to describe a common object, merely indicates that different instances of like objects are being referred to and are not intended to imply that the objects so described must be in a given sequence, either temporally, spatially, in ranking or in any other manner.

In the following detailed description, various aspects of the illustrative implementations will be described using terms commonly employed by those skilled in the art to convey the substance of their work to others skilled in the art.

The terms “substantially,” “close,” “approximately,” “near,” and “about,” generally refer to being within +/−20% of a target value as described herein or as known in the art. Similarly, terms indicating orientation of various elements, e.g., “coplanar,” “perpendicular,” “orthogonal,” “parallel,” or any other angle between the elements, generally refer to being within +/−5-20% of a target value as described herein or as known in the art.

In addition, the terms “comprise,” “comprising,” “include,” “including,” “have,” “having” or any other variation thereof, are intended to cover a non-exclusive inclusion. For example, a method, process, or device, that comprises a list of elements is not necessarily limited to only those elements but may include other elements not expressly listed or inherent to such method, process, or device. Also, the term “or” refers to an inclusive “or” and not to an exclusive “or.”

The systems, methods and devices of this disclosure each have several innovative aspects, no single one of which is solely responsible for all desirable attributes disclosed herein. Details of one or more implementations of the subject matter described in this specification are set forth in the description and the accompanying drawings.

1. A method, comprising:
determining a quantization level for a neural network model based on one or more first attributes about an execution of the neural network model by one or more computing systems;
computing a parameter value for an internal parameter of the neural network model using a value of the internal parameter determined from training the neural network model, wherein the computed parameter value corresponds to the quantization level;
selecting the quantization level based on one or more second attributes about the execution of the neural network model by the one or more computing systems; and
transmitting a signal to the one or more computing systems to cause the one or more computing systems to use the computed parameter value to execute the neural network model.

2. The method of claim 1, wherein the execution of the neural network model comprises the neural network model performing inference on input data.

3. The method of claim 1, wherein computing the parameter value comprises:
applying a Hadamard transform to the value of the internal parameter to obtain a transformed parameter.

4. The method of claim 3, wherein computing the parameter value comprises:
quantizing the transformed parameter according to the quantization level.

5. The method of claim 1, further comprising:
loading the computed parameter value into one or more memories of the one or more computing systems.

6. The method of claim 1, wherein selecting the quantization level comprises:
selecting the quantization level from one or more quantization levels at random.

7. The method of claim 1, wherein selecting the quantization level comprises:
selecting the quantization level from one or more quantization levels based on user input or a best guess estimation.

8. The method of claim 1, wherein selecting the quantization level comprises:
determining the selected quantization level that results in a lowest amount of information loss in the neural network model relative to one or more amounts of information loss of one or more other quantization levels; or
determining the selected quantization level that results in a highest amount of information loss in the neural network model relative to one or more amounts of information loss of one or more other quantization levels.

9. One or more non-transitory computer-readable media storing instructions that, when executed by one or more processors, cause the one or more processors to:
determine a quantization level for a neural network model based on one or more first attributes about an execution of the neural network model by one or more computing systems;
compute a parameter value for an internal parameter of the neural network model using a value of the internal parameter determined from training the neural network model, wherein the computed parameter value corresponds to the quantization level;
select the quantization level based on one or more second attributes about the execution of the neural network model by the one or more computing systems; and
transmit a signal to the one or more computing systems to cause the one or more computing systems to use the computed parameter value to execute the neural network model.

10. The one or more non-transitory computer-readable media of claim 9, wherein the instructions further cause the one or more processors to:
measure a first quality metric quantifying an impact of quantization caused by a first available quantization level on a first operation of the neural network model.

11. The one or more non-transitory computer-readable media of claim 9, wherein the instructions further cause the one or more processors to:
measure a second quality metric quantifying an impact of quantization caused by a first available quantization level on one or more operations up to a first operation of the neural network model.

12. The one or more non-transitory computer-readable media of claim 9, wherein selecting the quantization level comprises:
selecting the quantization level further based on one or more quality metrics quantifying a degradation impact caused by the quantization level.

13. The one or more non-transitory computer-readable media of claim 9, wherein the instructions further cause the one or more processors to:
transmit an update signal to signal a decrease in quality of the neural network model to a decision engine.

14. The one or more non-transitory computer-readable media of claim 9, wherein the instructions further cause the one or more processors to:
compute a further parameter value for the internal parameter of the neural network model using the value of the internal parameter determined from training the neural network model, wherein the further computed parameter value corresponds to a further quantization level; and
transmit a further signal corresponding to the further quantization level to the one or more computing systems to use the further computed parameter value to execute the neural network model.

15. The one or more non-transitory computer-readable media of claim 14, wherein the instructions further cause the one or more processors to:
load the further computed parameter value into one or more memories of the one or more computing systems.

16. The one or more non-transitory computer-readable media of claim 14, wherein the instructions further cause the one or more processors to:
determining the further quantization level based on one or more performance predictions of the neural network model.

17. The one or more non-transitory computer-readable media of claim 16, wherein the one or more performance predictions are generated based on one or more collected analytics about the neural network model.

18. The one or more non-transitory computer-readable media of claim 9, wherein the instructions further cause the one or more processors to:
determine a shift in a utilization level of the one or more computing systems; and
determine an updated quantization level based on the shift in the utilization level.

19. A system, comprising:
one or more processors for executing instructions; and
a non-transitory computer-readable memory storing the instructions, the instructions causing the one or more processors to:
determine a quantization level for a neural network model based on one or more first attributes about an execution of the neural network model by one or more computing systems;
compute a parameter value for an internal parameter of the neural network model using a value of the internal parameter determined from training the neural network model, wherein the computed parameter value corresponds to the quantization level;
select the quantization level based on one or more second attributes about the execution of the neural network model by the one or more computing systems; and
transmit a signal to the one or more computing systems to cause the one or more computing systems to use the computed parameter value to execute the neural network model.

20. The system of claim 19, wherein:
the one or more first attributes comprise one or more preferences of one or more users associated with the one or more computing systems, and a number of operations in the neural network model; and
the one or more second attributes comprise a level of utilization of the one or more computing systems.
